(19) United States
(12) Patent Application Publication
(10) Pub. No.: US 2026/0270830 A1
(43) Pub. Date: Sep. 10, 2026

(54) PARALLEL CONDITIONAL INTER-CELL HANDOVER

(71) Applicant: Boost SubscriberCo L.L.C., Englewood, CO (US)

(72) Inventors: Shubangi Kondapally, Littleton, CO (US); Rohit Singh, Denver, CO (US)

(21) Appl. No.: 19/071,323

(22) Filed: Mar. 5, 2025

(51) Int. Cl. H04W 36/36; H04B 17/318; H04W 36/00; H04W 74/0833

(52) U.S. Cl. CPC H04W 36/362; H04B 17/328; H04W 36/0069; H04W 74/0833

(57) ABSTRACT

A disclosed method may include (i) receiving, by a user equipment (UE), configuration information for multiple candidate target cells for Conditional Handover (CHO), (ii) determining, by the UE, that execution conditions are satisfied for at least two of the multiple candidate target cells, and (iii) initiating, by the UE, parallel CHO attempts to the at least two candidate target cells, in response to determining that the execution conditions are satisfied for the at least two candidate target cells, such that multiple CHO attempts are in progress simultaneously prior to any of the at least two CHO attempts being successfully completed.

### BRIEF SUMMARY

This disclosure is generally directed to systems, methods, and computer-readable media relating to parallel conditional inter-cell handover. In the field of wireless communications, cellular networks may encounter various challenges related to maintaining seamless connectivity for mobile devices. One such challenge may involve the process of transitioning a user equipment (UE) from one cell to another, often referred to as handover. As UEs move through different coverage areas, they may need to switch their connection from one cell to another to maintain signal quality and network performance. This process may become particularly complex in dense urban environments or areas with rapidly changing signal conditions. In some scenarios, existing handover techniques may struggle to keep pace with the dynamic nature of modern network environments, potentially leading to dropped calls, interrupted data sessions, or degraded service quality. These issues may be further exacerbated in situations where multiple potential target cells are available, each offering varying levels of signal strength and quality at different points in time. The ability to efficiently and reliably execute handovers in such complex scenarios may play a role in overall network performance and user experience. Moreover, the increasing demand for high-speed data services and low-latency applications may place additional strain on handover procedures, as even brief interruptions in connectivity may result in noticeable degradation of service quality. In some cases, UEs may find themselves in areas where multiple cells offer similar signal strengths, making it challenging to determine the optimal target cell for handover. This situation may lead to frequent back-and-forth handovers between cells, which can be called ping-pong effects, and which may consume additional network resources and potentially impact user experience.

One potential technique to address these challenges may involve the implementation of parallel conditional inter-cell handover procedures. This technique may allow a UE to simultaneously evaluate and initiate handover processes with multiple potential target cells, rather than sequentially assessing each option. By doing so, the UE may increase its chances of successfully transitioning to the most suitable cell in a timely manner, even in rapidly changing network conditions. This parallel technique may offer several potential benefits over sequential handover methods. For instance, it may reduce the overall time involved in a complete a handover, as the UE may not necessarily wait for the completion or failure of one attempt before initiating another. Additionally, this technique may provide a higher degree of flexibility and adaptability, allowing the UE to quickly adjust its handover strategy based on real-time changes in signal strength or quality across multiple potential target cells. The parallel nature of this technique may also help mitigate the impact of temporary signal fluctuations or brief obstructions, as the UE may maintain multiple handover options simultaneously, potentially reducing the likelihood of failed handovers or dropped connections. Furthermore, by evaluating multiple target cells in parallel, the UE may be better equipped to make more informed decisions about which cell offers the best long-term connectivity prospects, potentially reducing the frequency of subsequent handovers and improving overall network stability. This technique may also be particularly beneficial in scenarios where the UE is moving at high speeds, such as in vehicles or trains, where the relative signal strengths of nearby cells may change rapidly and unpredictably.

To implement the parallel conditional inter-cell handover technique effectively, a comprehensive system may incorporate several key components and/or functionalities. One such component may be a dynamic cell sorting and/or selection mechanism that continuously updates and/or re-evaluates the list of potential target cells based on the latest measurement reports and/or network conditions. This mechanism may allow the UE to adapt its handover strategy in real-time, focusing its efforts on the most promising candidates as network conditions evolve. The sorting algorithm may take into account various parameters such as Reference Signal Received Power (RSRP), Reference Signal Received Quality (RSRQ), and/or other relevant metrics to create a prioritized list of target cells. This dynamic sorting process may help ensure that the UE's resources are directed towards the more viable handover options, potentially improving the overall success rate of handover attempts. In some examples, the UE may maintain a list of up to eight candidate cells, as specified by certain network standards, and/or may continuously update this list based on the latest measurements. The UE may then select the top two or more candidates from this list for parallel handover attempts, balancing the benefits of parallel attempts with the desire to conserve resources. Another important aspect of this system may be the implementation of intelligent retry limitations and/or backoff procedures. These features may help prevent the UE from repeatedly attempting handovers to cells that have previously failed or shown poor performance, thereby conserving resources and/or improving overall efficiency. The retry mechanism may incorporate adaptive thresholds that adjust based on past handover performance, network conditions, and/or UE mobility patterns. This adaptive technique may help strike a balance between persistence in attempting handovers and/or avoiding excessive resource consumption on unlikely candidates.

In some examples, the parallel conditional inter-cell handover technique may also incorporate advanced predictive analytics and/or machine learning algorithms to further enhance its performance. These technologies may enable the UE to learn from past handover experiences and/or network patterns, potentially improving its ability to anticipate and/or prepare for upcoming handover scenarios. By analyzing historical data on cell performance, signal propagation patterns, and/or user movement trends, the UE may be able to make more informed decisions about which cells to target for parallel handover attempts. This predictive capability may be particularly valuable in complex urban environments or areas with frequent signal fluctuations, where reactive handover methods may struggle to keep pace with rapidly changing conditions. The system may also employ sophisticated decision-making algorithms that consider multiple factors when selecting target cells for parallel handover attempts. These factors may include not only signal strength and/or quality measurements but also historical performance data, current network load conditions, and/or predictions of future signal trends based on the UE's movement patterns. By taking a holistic approach to cell selection, the system may be better equipped to identify the most promising candidates for successful handovers, even in challenging network environments. Additionally, the parallel handover technique may incorporate mechanisms for quickly abandoning unsuccessful handover attempts and/or reallocating resources to more promising candidates. This agility may be helpful in scenarios where network conditions are highly dynamic, allowing the UE to adapt rapidly to changing circumstances and/or maximize its chances of maintaining a stable connection.

In some examples, a method includes (i) receiving, by a user equipment (UE), configuration information for multiple candidate target cells for Conditional Handover (CHO), (ii) determining, by the UE, that execution conditions are satisfied for at least two of the multiple candidate target cells, and (iii) initiating, by the UE, parallel CHO attempts to the at least two candidate target cells, in response to determining that the execution conditions are satisfied for the at least two candidate target cells, such that multiple CHO attempts are in progress simultaneously prior to any of the at least two CHO attempts being successfully completed.

In some examples, receiving the configuration information comprises receiving the information from one of: a source base station, a master node in a dual connectivity scenario, or a central network entity.

In some examples, the method conforms to 3GPP TS 38.300 or 3GPP TS 38.331.

In some examples, the method further comprises operating in one of: a first mode where only one target cell responds, a second mode where multiple target cells respond, or a third mode where no target cells respond.

In some examples, operating in the first mode comprises: attempting CHO to a first target cell and a second target cell and proceeding with CHO to the first target cell when a response is received from the first target cell and no response is received from the second target cell within a time limit.

In some examples, operating in the second mode comprises: attempting CHO to a first target cell and a second target cell and proceeding with CHO to whichever of the first target cell or second target cell responds first.

In some examples, operating in the third mode comprises: attempting CHO to a first target cell and a second target cell, determining that neither the first target cell nor the second target cell responded within a time limit, and attempting CHO to a third target cell and a fourth target cell.

In some examples, the method further comprises sorting candidate target cells based on signal strength prior to attempting CHO.

In some examples, the method further comprises updating a list of candidate target cells based on measurement reports in response to determining that neither the first target cell nor the second target cell responded within the time limit.

In some examples, the method further comprises re-evaluating execution conditions for the updated list of candidate target cells, determining that the first target cell still satisfies the execution conditions due to consistent signal strength, and re-attempting CHO to the first target cell.

In some examples, the method further comprises re-evaluating execution conditions for the updated list of candidate target cells, determining that neither the first target cell nor the second target cell satisfies the execution conditions due to degraded signal quality, and attempting CHO to two new target cells from the updated list.

In some examples, the method further comprises limiting a number of parallel CHO attempts to two.

In some examples, initiating parallel CHO attempts comprises sending Random Access Channel (RACH) messages to the at least two candidate target cells.

In some examples, the at least two candidate target cells comprise at least three candidate target cells such that parallel CHO attempts are initiated to each of the at least three candidate target cells.

In some examples, the method further comprises establishing a Radio Resource Control (RRC) connection with a first target cell that successfully completes the CHO attempt.

In some examples, the execution conditions comprise at least one of a Reference Signal Received Power (RSRP) threshold or a Reference Signal Received Quality (RSRQ) threshold.

In some examples, a non-transitory computer-readable medium has instructions stored thereon that, when executed by at least one physical computing processor, cause a computing device to perform operations comprising (i) receiving, by a user equipment (UE), configuration information for multiple candidate target cells for Conditional Handover (CHO), (ii) determining, by the UE, that execution conditions are satisfied for at least two of the multiple candidate target cells, and (iii) initiating, by the UE, parallel CHO attempts to the at least two candidate target cells, in response to determining that the execution conditions are satisfied for the at least two candidate target cells, such that multiple CHO attempts are in progress simultaneously prior to any of the at least two CHO attempts being successfully completed.

In some examples, a system comprises at least one physical computing processor of a computing device and a non-transitory computer-readable medium that has instructions stored thereon that, when executed by the at least one physical computing processor, cause the computing device to perform operations comprising (i) receiving, by a user equipment (UE), configuration information for multiple candidate target cells for Conditional Handover (CHO), (ii) determining, by the UE, that execution conditions are satisfied for at least two of the multiple candidate target cells, and (iii) initiating, by the UE, parallel CHO attempts to the at least two candidate target cells, in response to determining that the execution conditions are satisfied for the at least two candidate target cells, such that multiple CHO attempts are in progress simultaneously prior to any of the at least two CHO attempts being successfully completed.

### BRIEF DESCRIPTION OF THE DRAWINGS

For a better understanding of the present invention, reference will be made to the following Detailed Description, which is to be read in association with the accompanying drawings:

FIG. 1 shows a flow diagram for a method relating to parallel conditional inter-cell handover.

FIGS. 2-3 show a signaling diagram illustrating a basic handover (BHO) procedure.

FIG. 4 shows two signaling diagrams comparing scenarios where UE measurements cannot reach the base station and where the handover command from the base station is not reachable to the UE.

FIG. 5 shows a signaling diagram illustrating the initial steps of a conditional handover (CHO) procedure.

FIG. 6 shows a signaling diagram illustrating the completion steps of a conditional handover (CHO) procedure.

FIG. 7 shows three signaling diagrams illustrating different scenarios in a parallel conditional handover procedure.

FIG. 8 shows a multi-panel illustration of parallel conditional handover attempts.

FIG. 9 shows a flowchart of UE decision-making process for parallel CHO.

FIG. 10 shows a multi-panel illustration of dynamic cell sorting and selection for CHO.

FIG. 11 shows a diagram of an example computing system that may facilitate the performance of one or more of the methods described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

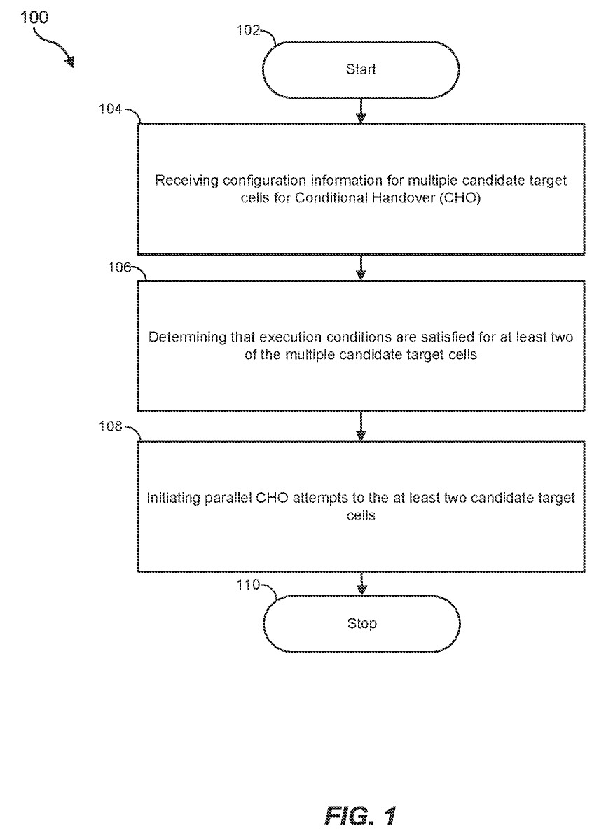

FIG. 1 shows a flow diagram for a method 100 relating to parallel conditional inter-cell handover. At step 102, method 100 may start. At step 104, method 100 includes receiving, by a user equipment (UE), configuration information for multiple candidate target cells for Conditional Handover (CHO). At step 106, method 100 includes determining, by the UE, that execution conditions are satisfied for at least two of the multiple candidate target cells. At step 108, method 100 includes initiating, by the UE, parallel CHO attempts to the at least two candidate target cells, in response to determining that the execution conditions are satisfied for the at least two candidate target cells, such that multiple CHO attempts are in progress simultaneously prior to any of the at least two CHO attempts being successfully completed. Additionally, or alternatively, the multiple CHO attempts may be in progress simultaneously before one or more of: receiving a first Random Access Response (RAR) from any target cell, transmitting a Radio Resource Control (RRC) Reconfiguration Complete message to any target cell, receiving an uplink grant from any target cell, initiating data transmission on a new data radio bearer (DRB) with any target cell, completing security activation with any target cell, receiving a handover command from the source cell, releasing the connection with the source cell, completing measurement gap configuration for any target cell, and/or establishing a protocol data unit (PDU) session with any target cell. These events may occur in parallel for multiple target cells, potentially allowing for faster and/or more efficient handover processes compared to sequential handover techniques. At step 110, method 100 ends.

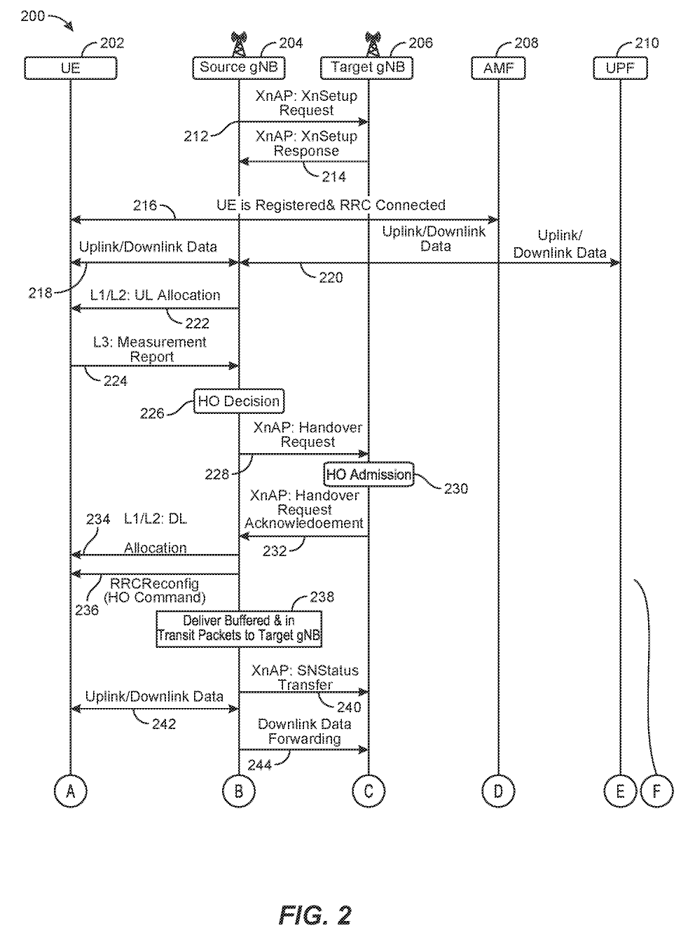

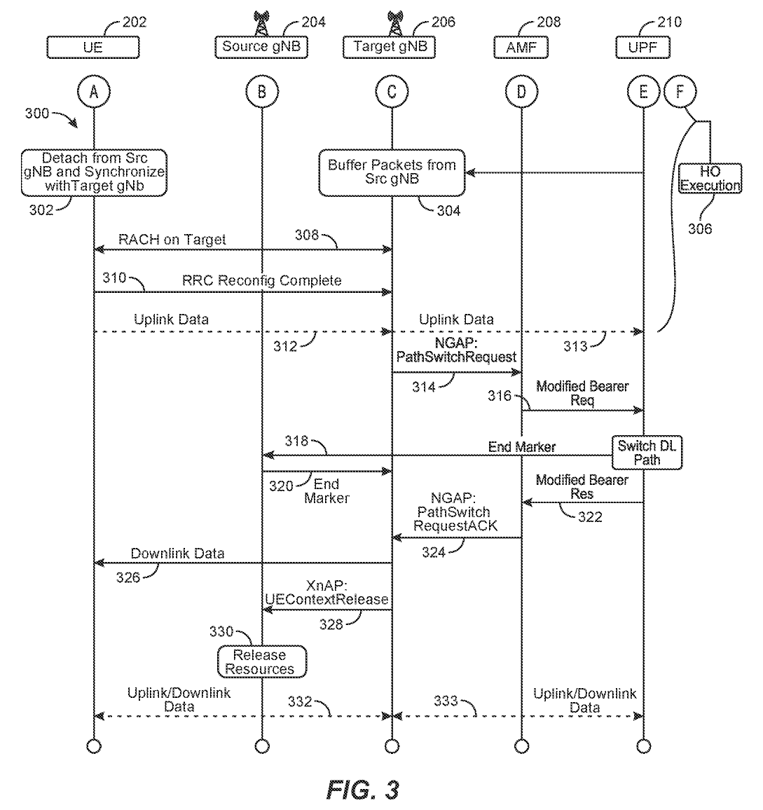

FIGS. 2 and 3 show an example signaling diagram illustrating a basic handover (BHO) procedure. The diagram presents a sequential timing representation, with time progressing from top to bottom, across five main entities: a user equipment (UE) 202, a source gNB 204, a target gNB 206, an Access and/or Mobility Management Function (AMF) 208, and/or a User Plane Function (UPF) 210. These entities may interact through various messages and/or signals to facilitate the handover process. The handover procedure may involve multiple steps and/or exchanges of information between these network elements, potentially ensuring a smooth transition of the UE 202 from the source gNB 204 to the target gNB 206 while maintaining service continuity. This process may be designed to minimize interruptions in the user's connectivity and/or data transmission, which may be helpful in scenarios where the UE 202 is moving between coverage areas or when network conditions change.

In some examples, the handover procedure may begin with an initial setup between the source gNB 204 and/or the target gNB 206. This setup may be initiated by the source gNB 204 sending an XnAP: XnSetup Request 212 to the target gNB 206. The XnAP: XnSetup Request 212 may contain information about the source gNB 204 and/or its capabilities, potentially allowing the target gNB 206 to prepare for potential handovers. The target gNB 206 may then respond with an XnAP: XnSetup Response 214, potentially establishing a connection between the two base stations. This XnAP: XnSetup Response 214 may include information about the target gNB 206's capabilities and/or readiness to accept handovers. This initial exchange may lay the groundwork for potential future handovers between these nodes, potentially improving the efficiency of subsequent handover processes. Following the setup, the AMF 208 may inform the source gNB 204 that the UE 202 is registered and/or in an RRC Connected state 216. This status update 216 may indicate that the UE 202 is actively connected to the network and/or may be ready for potential handover procedures. The RRC Connected state 216 may allow for more immediate communication between the network and/or the UE 202, which may be helpful for initiating and/or executing handover procedures quickly when needed.

Once the UE 202 is connected, bi-directional communication may occur between the UE 202 and/or the source gNB 204, as well as between the source gNB 204 and/or the UPF 210, represented by uplink/downlink data flows 218 and/or 220 respectively. These data flows 218 and/or 220 may represent the ongoing user traffic and/or control signaling that may be occurring during normal operation before the handover process begins. The uplink/downlink data flow 218 between the UE 202 and/or the source gNB 204 may include user data, such as voice calls, internet browsing, or application data, as well as control information for maintaining the connection. Similarly, the uplink/downlink data flow 220 between the source gNB 204 and/or the UPF 210 may carry this user data and/or control information between the radio access network and/or the core network. These ongoing data flows 218 and/or 220 may be maintained and/or transferred seamlessly during the handover process to ensure service continuity for the user.

In some scenarios, the source gNB 204 may allocate uplink resources to the UE 202 through an L1/L2: UL allocation message 222. This allocation message 222 may enable the UE 202 to send measurement reports to the source gNB 204, which may be helpful in determining when a handover may be appropriate. The L1/L2: UL allocation message 222 may specify the time, frequency, and/or other parameters for the UE 202 to use when sending its measurements. Subsequently, the UE 202 may transmit an L3 measurement report 224 to the source gNB 204, potentially providing information about the signal quality of neighboring cells. This L3 measurement report 224 may include metrics such as Reference Signal Received Power (RSRP), Reference Signal Received Quality (RSRQ), and/or other parameters that may help assess the quality of the current connection and/or potential target cells. Based on this report 224, the source gNB 204 may make a handover decision 226, determining that a handover to the target gNB 206 may be beneficial. This decision-making process 226 may involve analyzing various factors such as signal strength, quality, network load, and/or other relevant parameters to determine if a handover may improve the UE's connectivity or overall network performance.

Once the handover decision 226 is made, the source gNB 204 may initiate the handover process by sending an XnAP: Handover Request 228 to the target gNB 206. This XnAP: Handover Request 228 may contain information about the UE 202 and/or the desired handover, such as the UE's current configuration, security context, and/or quality of service conditions. The target gNB 206 may then perform admission control 230 to determine if it may accommodate the incoming UE 202. This admission control process 230 may involve checking available resources, current network load, and/or other factors to ensure that the target gNB 206 may provide adequate service to the UE 202 after the handover. If admission is granted, the target gNB 206 may send an XnAP: Handover Request Acknowledgement 232 back to the source gNB 204, confirming its readiness to accept the handover. This XnAP: Handover Request Acknowledgement 232 may include information about the resources allocated for the UE 202 at the target gNB 206, as well as any changes in configuration that the UE 202 may need to apply.

In some examples, the source gNB 204 may then allocate downlink resources to the UE 202 through an L1/L2: DL Allocation message 234. This allocation 234 may prepare the UE 202 to receive the handover command, facilitating the UE 202 in listening on the correct time and/or frequency resources. The source gNB 204 may subsequently send an RRCReconfig (HO Command) 236 to the UE 202, instructing it to perform the handover to the target gNB 206. This RRCReconfig message 236 may contain the information for the UE 202 to connect to the target gNB 206, such as the new cell's physical cell ID, frequency, and/or initial configuration parameters. Concurrently, the source gNB 204 may begin delivering buffered and/or in-transit packets 238 to the target gNB 206 to potentially facilitate continuity of data service during the handover. This data forwarding 238 may help minimize packet loss and/or reduce interruptions in the user's service during the handover process. The source gNB 204 may also send an XnAP: SNStatus Transfer 240 to the target gNB 206, potentially providing information about the current status of data transmission for the UE 202. This XnAP: SNStatus Transfer 240 may include details such as the next expected sequence numbers for uplink and/or downlink transmissions, which may be helpful in maintaining data integrity during the handover process. During this time, uplink and/or downlink data transmission 242 may continue between the UE 202 and/or the source gNB 204, allowing for ongoing service while the handover is being prepared. Additionally, the source gNB 204 may forward downlink data 244 to the target gNB 206 to potentially minimize data loss during the transition. This data forwarding 244 may ensure that any packets in transit or buffered at the source gNB 204 are not lost during the handover process.

As the handover process continues in FIG. 3, the UE 202 may detach from the source gNB and/or synchronize with the target gNB 206 at step 302. This step 302 may involve the UE 202 releasing its connection with the source gNB 204 and/or establishing initial communication with the target gNB 206. The detachment and/or synchronization process 302 may include actions such as stopping uplink transmissions to the source gNB 204, tuning to the new frequency of the target gNB 206, and/or acquiring the target cell's timing and/or synchronization signals. Concurrently, the target gNB 206 may buffer packets received from the source gNB at step 304, ensuring that data continuity may be maintained during the transition. This buffering 304 may help prevent data loss and/or enable continuation of services once the UE 202 completes its handover.

The UE 202 and/or target gNB 206 may then engage in a Random Access Channel (RACH) procedure, represented by the bidirectional arrow 308, to establish the new connection. This RACH procedure 308 may involve the UE 202 sending a random access preamble to the target gNB 206, which may then respond with timing advance and/or uplink grant information. The RACH procedure 308 may be helpful in establishing initial uplink synchronization and/or allowing the UE 202 to request resources for subsequent transmissions. Following successful access, the UE 202 may send an RRC Reconfiguration Complete message 310 to the target gNB 206, confirming that it has successfully applied the new configuration. This message 310 may indicate that the UE 202 is now ready for normal operation with the target gNB 206.

In some examples, uplink data transmission may begin from the UE 202 to the target gNB 206, as indicated by the dashed arrows 312 and/or 313. These uplink transmissions 312 and/or 313 may represent the UE 202 starting to send user data through the new connection, potentially including both control information and/or user plane data. The target gNB 206 may then initiate a path switch procedure by sending an NGAP: PathSwitchRequest message 314 to the AMF 208. This PathSwitchRequest 314 may inform the core network that the UE 202 has successfully connected to the target gNB 206 and/or that the user plane path should be updated accordingly. This may trigger a series of network-side updates, including a Modified Bearer Request 316 sent from the AMF 208 to the UPF 210. The Modified Bearer Request 316 may instruct the UPF 210 to update its routing information for the UE 202's data flows.

The UPF 210 may then switch the downlink path 318 and/or send end markers to both the source and/or target gNBs. This path switch 318 may involve updating routing tables and/or forwarding rules within the UPF 210 to direct future downlink traffic to the target gNB 206 instead of the source gNB 204. The end markers sent during this process may help identify the last packets sent along the old path, potentially aiding in maintaining packet order and/or preventing duplicate transmissions. Once the path switch is complete, the AMF 208 may acknowledge this with an NGAP: PathSwitch RequestACK message 324 sent to the target gNB 206. This acknowledgment 324 may confirm that the core network has successfully updated its records and/or is now routing data for the UE 202 through the target gNB 206.

The handover process may conclude with the target gNB 206 sending downlink data 326 to the UE 202 through the new connection. This downlink data transmission 326 may represent the resumption of normal service for the UE 202 through its new serving cell. The target gNB 206 may also send an XnAP: UEContextRelease message 328 to the source gNB 204, allowing it to release the resources associated with the UE 202. This UEContextRelease message 328 may signal that the handover is complete and/or that the source gNB 204 may free up any resources it was holding for the UE 202, such as radio resources, buffered data, or context information. Finally, bidirectional data transmission may be established between the UE 202 and/or the target gNB 206, as well as between the target gNB 206 and/or the UPF 210, as indicated by arrows 332 and/or 333. These bidirectional data flows 332 and/or 333 may represent the full restoration of normal service for the UE 202, with both uplink and/or downlink data now flowing through the new path established during the handover process.

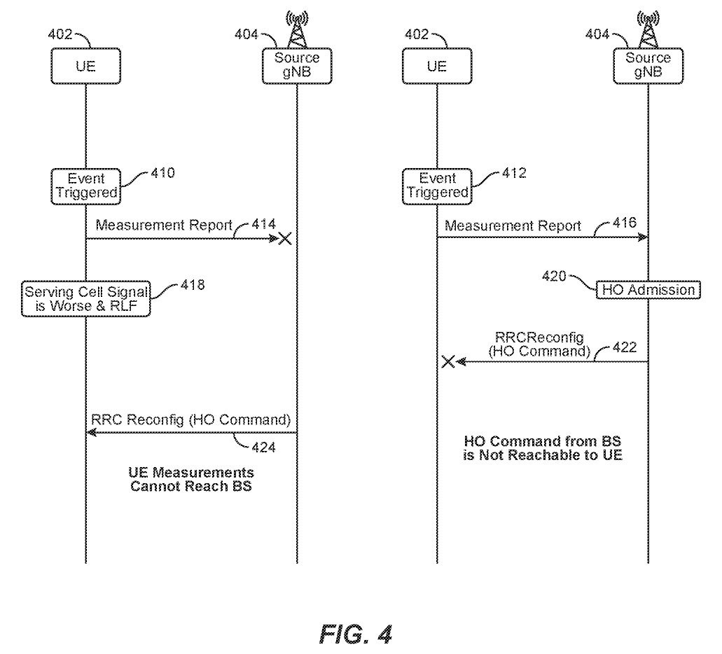

FIG. 4 shows an example pair of sequence diagrams illustrating potential challenges in handover procedures. The diagrams present timing representations, with time progressing from top to bottom, showing interactions between a user equipment (UE) 402 and a source gNB 404. The left side diagram is labeled "UE measurements cannot reach base station," while the right side diagram is labeled "Handover command from base station is not reachable to UE." These labels may indicate two distinct scenarios where communication failures may occur during a handover process. The scenarios depicted in FIG. 4 may highlight issues that may arise in cellular networks, particularly in environments with rapidly changing signal conditions or high user mobility. These situations may lead to degraded user experience, dropped calls, or interruptions in data service, which may be undesirable for network operators and/or users alike. By illustrating these potential failure points, FIG. 4 may provide context for understanding the motivation behind developing more robust handover techniques, such as Conditional Handover (CHO) and/or parallel CHO methods.

In the left diagram, the sequence may begin with an event triggered at step 410 by the UE 402. This event 410 may represent a condition that prompts the UE 402 to initiate a measurement process, such as degrading signal quality or detection of a potentially stronger neighboring cell. The triggering of this event 410 may be based on various factors, including but not limited to, signal strength thresholds, signal quality metrics, or timers set by the network. Following this trigger, the UE 402 may attempt to send a measurement report to the source gNB 404 at step 414. This measurement report may contain information about the radio environment, including signal strengths of the serving cell and/or neighboring cells, which may be used by the network to make informed handover decisions. However, an "X" at the end of the arrow for step 414 may indicate that this measurement report fails to reach the source gNB 404. This failure may occur due to various reasons, such as severe signal degradation, interference, or sudden obstacles in the radio path. Despite this failure, the diagram shows that the source gNB 404 may still attempt to send an RRC Reconfiguration (HO Command) message to the UE 402 at step 424. This attempt may be based on outdated or incomplete information, potentially leading to suboptimal handover decisions. At step 418, the UE 402 may experience a situation where the serving cell signal worsens and/or a Radio Link Failure (RLF) occurs. RLF may refer to a condition where the radio link between the UE 402 and/or the network deteriorates to a point where reliable communication is no longer possible. This scenario may illustrate a case where the network's lack of up-to-date information about the UE's radio conditions may result in delayed or inappropriate handover actions, potentially leading to service interruptions.

The right diagram may depict a similar initial sequence, with an event triggered at step 412 by the UE 402, followed by a successful transmission of a measurement report to the source gNB 404 at step 416. In this scenario, the source gNB 404 may successfully receive the measurement report and/or may proceed with handover preparation. The successful reception of the measurement report may allow the network to make a more informed decision about the necessity and/or timing of a handover. At step 420, a handover admission process may occur, potentially involving a target gNB (not shown in the diagram). This admission process may include resource allocation at the target cell, preparation of the target cell to receive the UE, and/or other network configurations to facilitate a smooth handover. Following this admission, the source gNB 404 may attempt to send an RRC Reconfiguration (HO Command) message to the UE 402 at step 422. This command may contain information for the UE 402 to connect to the target cell, including but not limited to, the target cell's identity, frequency, and/or initial access parameters. However, an "X" at the end of the arrow for step 422 may indicate that this handover command fails to reach the UE 402. This failure may occur at a vulnerable moment in the handover process, potentially leaving the UE 402 in a state where it may be aware of the appropriateness of performing a handover but may lack the information to execute it. Such a situation may lead to prolonged connection to a deteriorating serving cell, increased likelihood of call drops, and/or delays in reestablishing a stable connection.

These scenarios may illustrate potential vulnerabilities in handover procedures, particularly in challenging radio environments or high-mobility situations. In the first case, the network may not receive timely or accurate measurement information from the UE 402, which may lead to suboptimal or delayed handover decisions. This lack of up-to-date information may result in the network maintaining the UE's connection to a cell with deteriorating signal quality, potentially leading to service degradation or interruption. In the second case, even if the network makes a handover decision, the failure to deliver the handover command to the UE 402 may result in a failed handover attempt and/or potential service interruption. This scenario may be particularly problematic in situations where the serving cell's signal is rapidly degrading, as the UE 402 may be left without clear instructions on how to proceed with the handover. Both cases may highlight the sensitivity of the handover process to the reliability of the communication link between the UE 402 and/or the network.

The challenges depicted in FIG. 4 may provide context for the development of more robust handover techniques, such as Conditional Handover (CHO). CHO may aim to address these issues by allowing the network to provide the UE 402 with a set of candidate cells and/or conditions in advance. This technique may enable the UE 402 to autonomously execute a handover when predefined conditions are met, potentially reducing reliance on real-time communication between the UE 402 and/or the network at the moment of handover. By doing so, CHO may help mitigate the risk of handover failures in scenarios where either measurements from the UE 402 or commands from the network may fail to be transmitted due to poor signal conditions or rapidly changing network environments. The proactive nature of CHO may allow for more resilient handover processes, potentially improving the overall reliability of mobility management in cellular networks.

In some examples, the scenarios illustrated in FIG. 4 may serve as motivation for further enhancements to handover procedures, such as parallel conditional handover techniques. These enhancements may aim to improve the reliability and/or efficiency of handovers in challenging network conditions, potentially leading to better overall network performance and/or user experience. Parallel CHO techniques may build upon the concept of CHO by allowing the UE 402 to prepare for and/or initiate handover procedures with multiple potential target cells simultaneously. This parallel approach may provide additional redundancy and/or flexibility in the handover process, potentially further reducing the risk of handover failures in complex radio environments.

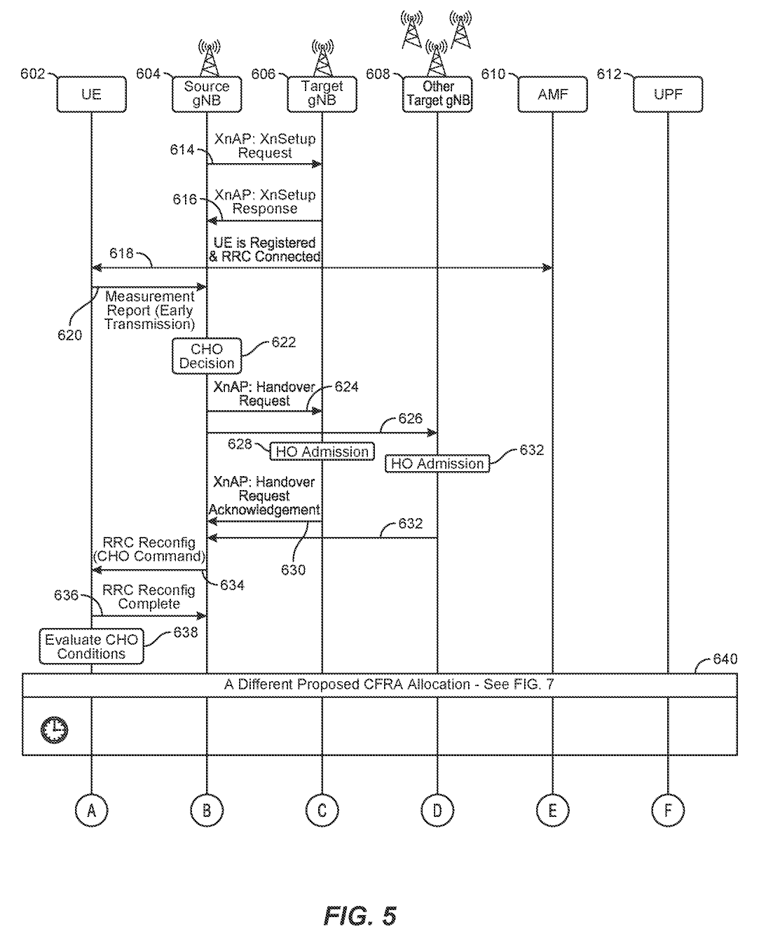

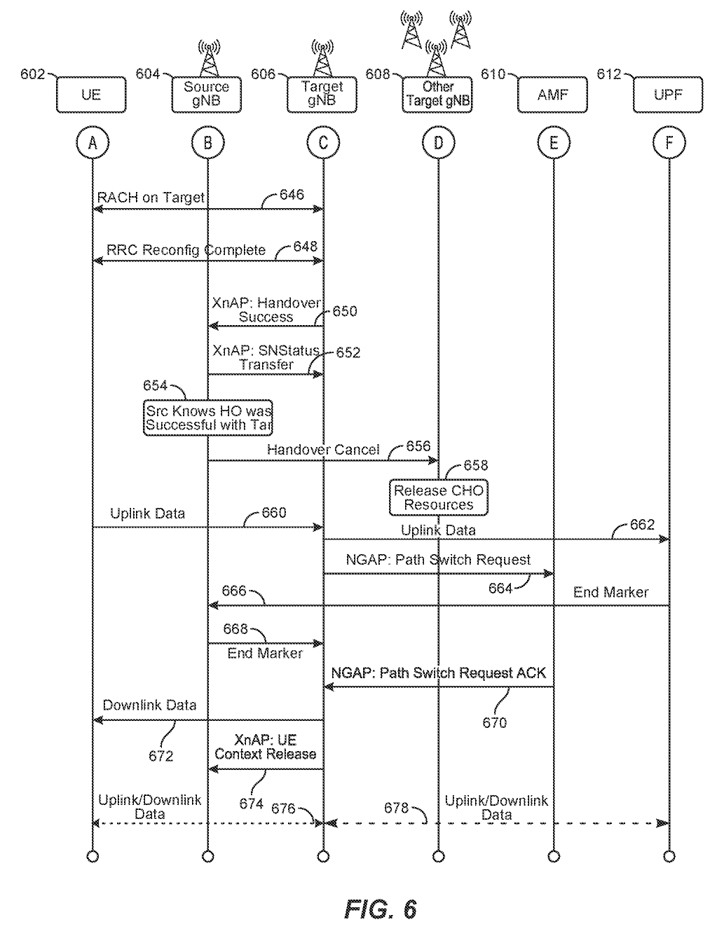

FIGS. 5 and 6 show an example sequence diagram illustrating a Conditional Handover (CHO) procedure. The diagrams present a timing representation, with time progressing from top to bottom, across six main entities: a user equipment (UE) 602, a source gNB 604, a target gNB 606, another target gNB 608, an Access and/or Mobility Management Function (AMF) 610, and/or a User Plane Function (UPF) 612. These entities may interact through various messages and/or signals to facilitate the CHO process, which may aim to improve handover reliability and/or efficiency in challenging network conditions. The CHO procedure may involve multiple steps and/or exchanges of information between these network elements, potentially ensuring a smooth transition of the UE 602 from the source gNB 604 to one of the target gNBs while maintaining service continuity. This process may be designed to minimize interruptions in the user's connectivity and/or data transmission, which may be helpful in scenarios where the UE 602 is moving between coverage areas or when network conditions change rapidly.

In some examples, the CHO procedure may begin with an initial setup between the source gNB 604 and/or the target gNB 606. This setup may be initiated by the source gNB 604 sending an XnAP: XnSetup Request 614 to the target gNB 606. The XnAP: XnSetup Request 614 may contain information about the source gNB 604 and/or its capabilities, potentially allowing the target gNB 606 to prepare for potential handovers. The target gNB 606 may then respond with an XnAP: XnSetup Response 616, potentially establishing a connection between the two base stations. This XnAP: XnSetup Response 616 may include information about the target gNB 606's capabilities and/or readiness to accept handovers. This initial exchange may lay the groundwork for potential future handovers between these nodes, potentially improving the efficiency of subsequent handover processes. Following the setup, a bidirectional arrow 618 between the UE 602 and/or the AMF 610 indicates that the UE 602 is registered and/or in an RRC Connected state. This status may indicate that the UE 602 is actively connected to the network and/or may be ready for potential handover procedures. The RRC Connected state may allow for more immediate communication between the network and/or the UE 602, which may be helpful for initiating and/or executing handover procedures quickly.

The UE 602 may then send a measurement report (early transmission) 620 to the source gNB 604. This early measurement report 620 may provide the network with timely information about the radio environment, which may be helpful in making proactive handover decisions. The measurement report 620 may contain information about the radio environment, including signal strengths of the serving cell and/or neighboring cells, which may be used by the network to make informed handover decisions. Based on this report 620, the source gNB 604 may make a CHO decision 622. This decision-making process 622 may involve analyzing various factors such as signal strength, quality, network load, and/or other relevant parameters to determine if preparing for a conditional handover may be beneficial. The CHO decision 622 may take into account not only the current radio conditions but also historical data and/or predictions of future network states, potentially allowing for more intelligent and/or anticipatory handover preparations.

Following the CHO decision 622, the source gNB 604 may send an XnAP: Handover Request 624 to the target gNB 606. This XnAP: Handover Request 624 may contain information about the UE 602 and/or the desired handover conditions, such as the UE's current configuration, security context, and/or quality of service requirements. Concurrently, a handover admission process may occur, involving the source gNB 604, target gNB 606, and/or other target gNB 608, as indicated by steps 626, 628, and/or 632. This admission process may involve checking available resources, current network load, and/or other factors to ensure that the potential target cells may provide adequate service to the UE 602 after the handover. The admission control process may consider factors such as the target cell's capacity, current load, and/or ability to meet the UE's quality of service requirements, potentially facilitating a scenario where the handover, if executed, may result in improved service for the UE 602.

The target gNB 606 may then send an XnAP: Handover Request Acknowledgement 630 back to the source gNB 604, potentially confirming its readiness to accept the handover. The other target gNB 608 may also send a similar acknowledgement (step 632). These acknowledgements may include information about the resources allocated for the UE 602 at the respective target gNBs, as well as any changes in configuration that the UE 602 may apply. The acknowledgements may also contain information about the specific conditions under which the handover should be executed, which may be used by the source gNB 604 to formulate the conditional handover command for the UE 602. This exchange between the source gNB 604 and/or target gNBs may be helpful in ensuring that the target cells have the necessary resources to support the UE 602 before proceeding with the handover preparation, potentially reducing the likelihood of handover failures.

The source gNB 604 may then send an RRC Reconfiguration (CHO Command) 634 to the UE 602. This command 634 may contain the information for the UE 602 to prepare for potential handovers to multiple target cells, including handover execution conditions. The RRC Reconfiguration message 634 may include details such as the identities of the target cells, radio resource configurations for each target cell, and/or the specific conditions under which the UE 602 should execute the handover to each target cell. The UE 602 may respond with an RRC Reconfiguration Complete message 636, confirming that it has received and/or applied the CHO configuration. This confirmation may be helpful in ensuring that the UE 602 is properly prepared for potential handovers before it enters a state where communication with the source gNB 604 may become unreliable.

After receiving the CHO configuration, the UE 602 may begin to evaluate CHO conditions 638. This evaluation process may involve continuously monitoring the radio environment and/or comparing the measured parameters against the conditions specified in the CHO command. The UE 602 may perform this evaluation independently, without constant communication with the source gNB 604, potentially allowing for faster and/or more autonomous handover decisions in rapidly changing network conditions. The CHO conditions may include various parameters such as Reference Signal Received Power (RSRP), Reference Signal Received Quality (RSRQ), and/or Signal-to-Interference-plus-Noise Ratio (SINR) thresholds for different candidate cells. The UE 602 may continuously measure these parameters for the serving cell and/or the candidate cells, and/or may compare them against the specified thresholds. This ongoing evaluation may allow the UE 602 to quickly identify when the radio conditions have changed sufficiently to warrant a handover, potentially reducing the likelihood of dropped connections or service interruptions in challenging radio environments.

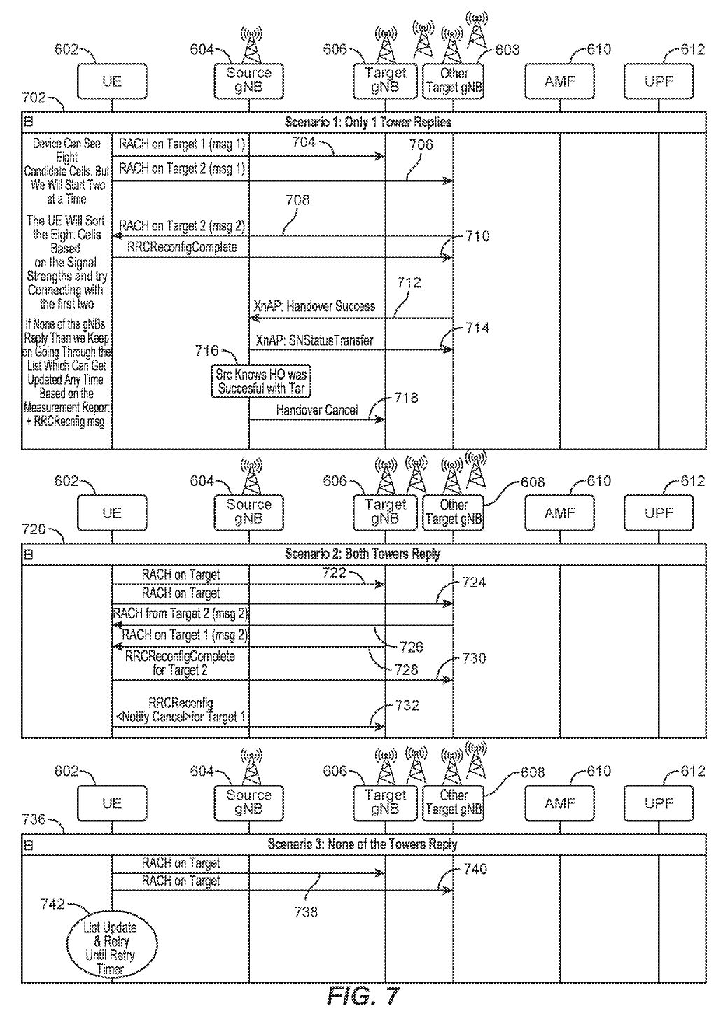

A block 640 labeled "A Different Proposed CFRA Allocation – See FIG. 7" is shown in the diagram. CFRA may refer to Contention-Free Random Access. This block may indicate the location where a new procedure may be inserted into the overall CHO flow, corresponding to each of the three scenarios to be shown in FIG. 7. The relevance of this block may relate to the timing and/or execution of parallel CHO attempts. In some example, the positioning of this block within the CHO procedure may suggest that the parallel CHO attempts may occur after the UE 602 has received and/or confirmed the CHO configuration, but before the actual handover execution. This placement may be relevant as it may allow for multiple handover options to be prepared simultaneously, potentially increasing the chances of a successful handover in challenging network conditions. The CFRA allocation mentioned in the label may refer to a technique where specific random access resources are reserved for the UE 602, potentially reducing contention and/or improving the reliability of the handover process. The parallel nature of the CHO attempts may allow the UE 602 to initiate handover procedures with multiple target cells simultaneously, potentially reducing the overall handover latency and/or improving the likelihood of a successful handover in rapidly changing network conditions.

FIG. 6 continues the CHO procedure, showing the potential handover execution and/or completion steps. A bidirectional step 646 between the UE 602 and/or the target gNB 606 indicates the Random Access Channel (RACH) procedure on the target cell. This RACH procedure 646 may involve the UE 602 sending a random access preamble to the target gNB 606, which may then respond with timing advance and/or uplink grant information. The RACH procedure 646 may be a relevant step in the handover process, as it may allow the UE 602 to establish initial synchronization with the target cell and/or request resources for subsequent transmissions. The success of this RACH procedure 646 may be an indicator of whether the handover will be completed successfully. Following the RACH procedure, another bidirectional arrow shows the UE 602 sending an RRC Reconfiguration Complete message 648 to the target gNB 606, confirming the successful handover. This confirmation may indicate that the UE 602 has successfully applied the new configuration provided by the target gNB 606 and/or is ready for normal operation in the new cell. The completion of this step may mark the point at which the UE 602 fully transitions its active connection from the source gNB 604 to the target gNB 606.

The target gNB 606 may then send an XnAP: Handover Success message 650 to the source gNB 604, informing it that the UE 602 has successfully accessed the target cell. This message 650 may serve as a confirmation that the handover has been executed successfully and/or that the target gNB 606 has assumed control of the UE 602's connection. In response, the source gNB 604 may send an XnAP: SNStatus Transfer message 652 to the target gNB 606. This status transfer message 652 may include information about the current state of data transmission for the UE 602, potentially helping to maintain data integrity during the handover process. The SNStatus Transfer 652 may contain details such as the next expected sequence numbers for uplink and/or downlink transmissions, which may be facilitate the prevention of data loss or duplication during the transition. This exchange of information between the source gNB 604 and/or the target gNB 606 may facilitate the handover from the perspective of higher-layer protocols and/or applications running on the UE 602.

Step 654 indicates that the source gNB 604 now knows the handover was successful with the target. This acknowledgment may trigger a series of cleanup actions in the network. Following this, the source gNB 604 may send a Handover Cancel message 656 to the other target gNB 608, which may then release any CHO resources 658 it had prepared for the UE 602. This cancellation and/or release of resources may help improve overall network efficiency by freeing up resources that are no longer needed for the handover. The release of these resources 658 may involve deallocating radio resources, clearing any temporary UE context information, and/or updating internal states in the other target gNB 608. This process may be helpful in ensuring that network resources are used efficiently and/or that the other target gNB 608 is ready to handle new connections or handover preparations for other UEs.

The UE 602 may begin sending uplink data 660 to the target gNB 606, which may then forward this data 662 to the UPF 612. This initiation of data transmission may indicate that the UE 602 has successfully established a working connection with the target gNB 606 and/or is ready for normal operation in the new cell. The ability to quickly resume data transmission after the handover may be helpful in minimizing service interruption for the user. Concurrently, the target gNB 606 may initiate a path switch procedure by sending an NGAP: Path Switch Request message 664 to the AMF 610. This path switch request 664 may trigger a series of network-side updates to ensure that the UE's data flows are properly routed through the new serving cell. The path switch procedure may involve updating routing tables in various network elements to reflect the UE's new point of attachment to the network, potentially ensuring that both uplink and/or downlink data can be correctly routed to and/or from the UE 602 through its new serving cell.

The UPF 612 may send an end marker 666 to the source gNB 604. Upon receiving this end marker 666, the source gNB 604 may forward it to the target gNB 606, which is represented by the end marker 668. This forwarding of the end marker from the source gNB 604 to the target gNB 606 may help identify the last packets sent along the old path, potentially aiding in maintaining packet order and/or preventing duplicate transmissions. The use of these forwarded end markers 666 and/or 668 may be helpful in increase the chances that all data in transit during the handover is correctly delivered and/or that the transition from the old path to the new path is handled smoothly at the packet level. This process may allow both the source gNB 604 and/or the target gNB 606 to synchronize their understanding of when the data flow has completely switched to the new path, potentially minimizing the risk of data loss or duplication during the handover procedure.

The AMF 610 may then acknowledge the path switch with an NGAP: Path Switch Request ACK message 670 sent to the target gNB 606. This acknowledgment 670 may confirm that the core network has successfully updated its records and/or is now routing data for the UE 602 through the target gNB 606. The completion of the path switch may mark the point at which the network fully recognizes the UE's new point of attachment and/or is ready to handle all traffic through the new path.

Following the path switch, the target gNB 606 may begin sending downlink data 672 to the UE 602. This initiation of downlink data transmission may indicate that the handover process is fully complete from both the radio access network and/or core network perspectives. The target gNB 606 may also send an XnAP: UE Context Release message 674 to the source gNB 604, allowing it to release the resources associated with the UE 602. This context release 674 may be the final step in cleaning up the old connection, potentially allowing the source gNB 604 to free up any remaining resources it was holding for the UE 602. Finally, bidirectional data transmission may be established between the UE 602 and/or the target gNB 606 (arrow 676), as well as between the target gNB 606 and/or the UPF 612 (arrow 678), indicating the completion of the handover process and/or the resumption of normal data services for the UE 602. These bidirectional data flows 676 and/or 678 may represent the full restoration of the UE's connectivity through its new serving cell. The establishment of these data paths may signify that the UE 602 is now fully operational in the target cell, with both uplink and/or downlink communications functioning normally. This final stage may be helpful in confirming that the entire handover procedure, from the initial preparation to the final execution and/or network path update, has been successfully completed.

FIG. 7 shows an example set of sequential timing diagrams illustrating three different scenarios in the Conditional Handover (CHO) process. The figure is divided into three main sections, each representing a distinct scenario encountered during the CHO procedure. These scenarios may correspond to different outcomes that may occur when a User Equipment (UE) attempts to perform parallel handovers to multiple target cells. The division of the figure into multiple scenarios may be helpful in demonstrating the adaptability and/or flexibility of the CHO technique in various network conditions. By presenting these different outcomes side by side, the figure may provide insights into how the CHO process may handle diverse situations that may arise during handover attempts in complex and/or dynamic network environments.

The top section of FIG. 7, labeled as timing diagram 702, illustrates Scenario 1, where only one tower replies to the handover attempt. This scenario may represent a situation where the UE successfully establishes a connection with one of the target cells, while the other target cell may not respond and/or may fail to complete the handover process. The timing diagram 702 shows interactions between six entities: UE 602, Source gNB 604, Target gNB 606, Other Target gNB 608, AMF 610, and/or UPF 612. In the Scenario 1 timing diagram 702, several steps are illustrated. The UE 602 may initiate the handover process by sending RACH (Random Access Channel) messages to two target cells in parallel. This is shown in steps 704 and/or 706, where RACH on Target 1 (msg 1) and RACH on Target 2 (msg 1) are sent to Target gNB 606 and Other Target gNB 608, respectively. This parallel RACH transmission may be a feature of this CHO technique, potentially allowing for faster and/or more reliable handover execution. The simultaneous or parallel initiation of handover attempts to multiple target cells may be helpful in scenarios where network conditions are rapidly changing and/or where the reliability of individual cells may be uncertain. By attempting connections with multiple cells in parallel, the UE may increase its chances of successfully completing a handover, even if one of the target cells fails to respond or experiences issues during the process. This approach may be particularly beneficial in challenging network environments, such as urban areas with high cell density and/or interference, or in high-mobility scenarios where the UE may be moving quickly between cell coverage areas.

The diagram then shows that Other Target gNB 608 responds with RACH on Target 2 (msg 2) in step 708, followed by the UE 602 sending an RRCReconfigurationComplete message to Other Target gNB 608 in step 710. This sequence may indicate that the handover to Other Target gNB 608 has been successfully completed. The successful handover may then be communicated to the Source gNB 604 through an XnAP: Handover Success message in step 712, followed by an XnAP: SNStatusTransfer in step 714. These messages may help ensure that the Source gNB 604 is aware of the successful handover and/or may facilitate the transfer of any necessary context information to the new serving cell. The inclusion of these inter-node communication steps in the diagram may highlight the importance of coordination between different network elements during the handover process. In some examples, this efficient information exchange may be helpful in minimizing service interruptions and/or ensuring a smooth transition of the UE's connection from one cell to another.

The Scenario 1 timing diagram 702 further illustrates the final stages of the successful handover process. Step 716 includes an annotation "Src Knows HO Was Successful with Tar" associated with Source gNB 604. This annotation may indicate the point at which the Source gNB 604 has become aware of the successful handover to the Other Target gNB 608, based on the previously received XnAP: Handover Success message. This notation in the diagram may be helpful in illustrating the Source gNB's updated understanding of the UE's connection status. Following the acknowledgment of successful handover, step 718 shows the Source gNB 604 sending a "Handover Cancel" message to Target gNB 606. This cancellation message may serve multiple purposes in the CHO process. Firstly, it may inform Target gNB 606 that its services are no longer required for this particular handover attempt, potentially allowing it to release any resources that may have been reserved for the UE. Secondly, this cancellation step may be helpful in maintaining network efficiency by promptly terminating any ongoing processes related to the unused handover attempt. In some scenarios, this quick cancellation may be particularly beneficial in high-traffic network environments, where efficient resource utilization may be helpful for overall network performance. The inclusion of this optional cancellation step in the diagram may also demonstrate the CHO technique's ability to manage multiple simultaneous handover attempts and/or gracefully handle scenarios where not all attempts are successful or necessary.

The middle section of FIG. 7, labeled as timing diagram 720, illustrates Scenario 2, where both towers reply to the handover attempt. This scenario may represent a situation where the UE successfully initiates handover processes with multiple target cells simultaneously, potentially demonstrating the parallel nature of the CHO technique. The timing diagram 720 shows a series of interactions between the UE 602 and/or multiple network entities, including Target gNB 606 and/or Other Target gNB 608, which may illustrate the complex decision-making process involved in selecting the most suitable target cell when multiple options are available. In some examples, this scenario may be helpful in understanding how the CHO technique may handle situations where multiple viable handover options exist, potentially leading to more robust and/or efficient handover processes in complex network environments. The ability to manage multiple simultaneous handover attempts may be particularly beneficial in scenarios where network conditions are rapidly changing and/or unpredictable, as it may provide the UE with greater flexibility in adapting to dynamic signal strengths and/or quality metrics from various nearby cells.

In this scenario, the UE 602 may initiate the handover process by sending RACH (Random Access Channel) messages to two target cells simultaneously or in parallel. This is shown in steps 722 and/or 724, where RACH messages are sent to Target gNB 606 and Other Target gNB 608, respectively. The parallel transmission of RACH messages to multiple target cells may be a feature of this CHO technique, potentially allowing for faster and/or more reliable handover execution in scenarios where network conditions may be rapidly changing or uncertain.

The diagram then shows that both target cells respond to the UE's RACH messages, with the UE choosing the first responder for handover completion. In step 726, Other Target gNB 608 sends a "RACH from Target 2 (msg 2)" to UE 602, followed by Target gNB 606 sending a "RACH on Target 1 (msg 2)" to UE 602 in step 728. The UE's decision to select the first responding cell, as illustrated in the subsequent steps, may serve as a helpful baseline heuristic for the CHO process, potentially minimizing handover latency in many scenarios. This "first-responder" technique may be beneficial in time-sensitive situations and/or may help simplify the decision-making process in complex network environments. The selection of the first responder may be based on the assumption that the cell able to process and/or respond to the RACH message most quickly may be in a better position to provide immediate and/or reliable service to the UE. Additionally, choosing the first responder may reduce the overall handover duration, potentially minimizing the risk of connection interruptions and/or improving the user experience during the transition between cells.

However, the CHO technique may also incorporate more sophisticated decision-making algorithms that consider various factors beyond response time. These factors may include signal strength measurements (such as RSRP and/or RSRQ), historical performance data of candidate cells, current network load conditions, and/or predicted future signal trends based on the UE's movement patterns. Additionally, the decision process may take into account quality of service requirements for active UE applications, potential interference levels, and/or the UE's current battery status. In some implementations, machine learning algorithms may be employed to dynamically adjust the weighting of these factors based on past handover successes and/or failures, potentially improving the overall efficiency and/or reliability of the CHO process over time. The incorporation of these additional factors may allow for more nuanced decision-making, potentially leading to improved handover outcomes in complex network environments. For example, if the first responding cell has a history of poor performance or is currently experiencing high load, the UE may choose to wait for responses from other candidate cells before making a final decision. This adaptive approach may be helpful in balancing the benefits of quick handover execution with the desire for long-term connection stability and/or quality.

The diagram illustrates the UE's decision-making process and/or subsequent actions in steps 730 and/or 732. In step 730, the UE 602 sends an "RRCReconfigComplete for Target 2" message to Other Target gNB 608, indicating that it has chosen to complete the handover process with this cell. This message may signify the UE's commitment to finalizing the handover with the selected target cell and/or may trigger further actions within the network to complete the transition. The RRCReconfigComplete message may contain information for establishing the new connection, such as security parameters, radio bearer configurations, and/or other relevant data. Simultaneously or shortly after, in optional step 732, the UE 602 sends an "RRCReconfig <Notify Cancel> for Target 1" message to Target gNB 606, effectively cancelling the handover attempt with this cell. This cancellation message may be helpful in promptly releasing any resources that may have been reserved for the potential handover, potentially improving overall network efficiency.

The bottom section of FIG. 7, labeled as timing diagram 736, illustrates an example of Scenario 3, where none of the towers replies to the respective handover attempt. This scenario may represent a situation where the UE initiates handover processes with multiple target cells simultaneously or in parallel, but does not receive responses from any of them. In this scenario, the UE 602 may initiate the handover process by sending RACH (Random Access Channel) messages to two target cells simultaneously or in parallel. This is shown in steps 738 and/or 740, where RACH messages are sent to Target gNB 606 and Other Target gNB 608, respectively. Following the RACH transmissions, an annotation 742 indicates that the UE 602 performs an analysis, stating "list update and retry until retry timer". This annotation may represent a complex decision-making process within the UE when faced with unsuccessful handover attempts. The "list update" portion of this analysis may involve the UE dynamically reassessing and/or modifying its list of candidate target cells based on the current network conditions and/or the outcomes of the recent handover attempts. This updating process may be helpful in adapting to rapidly changing network environments and/or improving the chances of successful handovers in subsequent attempts. The UE may consider various factors when updating its candidate list, such as signal strength measurements, historical performance data, and/or predictions of future network conditions based on the UE's movement patterns. In some implementations, the UE may maintain a list of up to eight candidate cells, continuously sorting and/or re-evaluating them based on the most recent measurements and/or handover attempt outcomes. The dynamic nature of this list update process may allow the UE to prioritize the most promising target cells for future attempts, potentially increasing the efficiency and/or success rate of subsequent handover attempts. Furthermore, this adaptive approach may be helpful in scenarios where network conditions are highly variable, as it may allow the UE to quickly adjust its handover strategies based on real-time changes in the radio environment.

The "retry until retry timer" portion of the analysis may refer to the UE's strategy for managing repeated handover attempts. This may involve implementing intelligent retry mechanisms with adaptive timers to balance the desire for quick handover execution with the desire to avoid excessive network signaling or battery drain. The retry timer may be dynamically adjusted based on factors such as the number of failed attempts, the urgency of the handover (e.g., due to rapidly degrading signal quality), and/or the overall network conditions. In some examples, the UE may employ exponential backoff strategies for retry attempts, gradually increasing the time between attempts if multiple failures occur. This approach may help prevent network congestion and/or conserve UE resources while still allowing for persistent handover efforts in challenging conditions. The intelligent retry mechanism may also incorporate learning algorithms that analyze patterns of successful and/or failed handover attempts to optimize future retry strategies. For instance, the UE may learn to avoid repeatedly attempting handovers to cells that have consistently failed in the past, or it may adjust its retry intervals based on the time of day or the UE's location, potentially leading to more efficient and/or effective handover processes over time. Additionally, the retry mechanism may be designed to interact with other network functions, such as load balancing or energy saving features, to help ensure that handover attempts are coordinated with broader network management strategies.

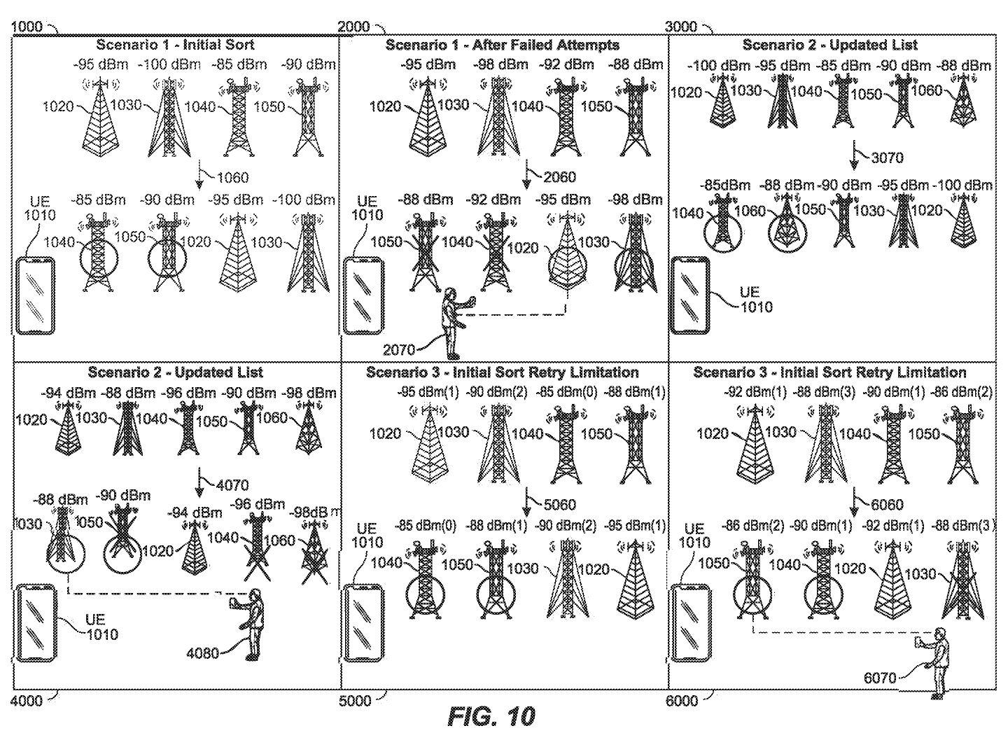

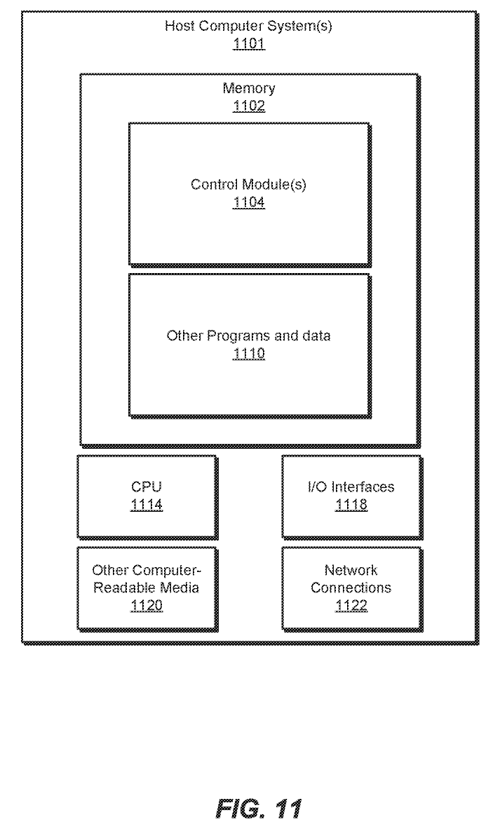

The procedures illustrated in timing diagram 736, particularly the list update and/or retry mechanisms represented by annotation 742, may be further elaborated in the context of FIGS. 10 and/or 11. FIG. 10 may provide a more detailed visual representation of an example dynamic cell sorting and/or selection process, illustrating how the UE may update and/or re-evaluate its list of candidate cells over multiple handover attempts. This figure may showcase the evolution of the candidate cell list across different network scenarios, potentially demonstrating how the UE adapts its selection criteria based on changing signal strengths, retry counts, and/or other relevant factors. FIG. 11 may offer an in-depth look at a multi-round nature of an example CHO process, potentially showing how the UE may adapt its handover strategies across multiple iterations, incorporating the list updates and/or retry mechanisms discussed in the context of timing diagram 736. This figure may provide a comprehensive view of the CHO technique's behavior over an extended period, illustrating how the UE may persistently attempt handovers while dynamically adjusting its approach based on ongoing network conditions and/or previous attempt outcomes.

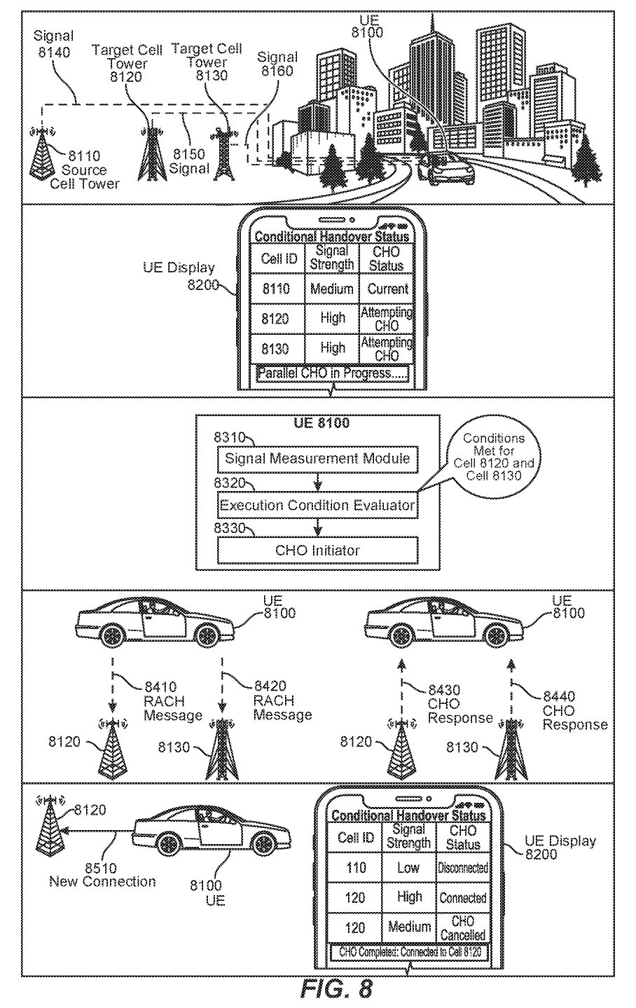

FIG. 8 shows an example multi-panel illustration of parallel Conditional Handover (CHO) attempts. The figure may provide a visual representation of the parallel CHO process, potentially illustrating various aspects of the technique in different scenarios and/or from different perspectives. The various panels may work together to provide a holistic view of how parallel CHO may function in a real-world scenario, from the network infrastructure to the user equipment (UE) internal processes and/or the end-user experience.

In the top panel, FIG. 8 may depict an urban cityscape overview. This panel shows a bustling city skyline with multiple tall buildings, representing a dense urban environment where parallel CHO techniques may be particularly beneficial. The urban setting may illustrate the challenges faced by mobile networks in areas with high user density and/or complex signal propagation characteristics, potentially emphasizing the value of advanced handover techniques. In the foreground, three distinct cell towers may be visible, each potentially representing different network nodes involved in the CHO process. The leftmost tower may be labeled as "Source Cell Tower 8110", potentially indicating the current serving cell for a user equipment (UE). The middle and/or rightmost towers may be labeled as "Target Cell Tower 8120" and/or "Target Cell Tower 8130" respectively, possibly representing potential handover targets. These towers may have distinct designs, potentially mixing 4G and/or 5G technologies, which may reflect the heterogeneous nature of modern cellular networks and/or the desire for handover techniques that may work across different radio access technologies. On a street between the buildings, the panel may show a car labeled as "UE 8100," which can include a smartphone inside. This representation of the UE 8100 as a car may illustrate the mobile nature of the device and/or the challenges associated with maintaining connectivity while in motion. From the UE 8100, three dotted lines may extend towards each of the cell towers, representing wireless signals. These lines may be labeled as "Signal 8140", "Signal 8150", and/or "Signal 8160" respectively. The presence of multiple signal lines may visually represent the UE's ability to communicate with and/or measure signals from multiple cells simultaneously, which may be one relevant aspect of the parallel CHO technique. The varying lengths or strengths of these signal lines may indicate different signal qualities or strengths from each cell tower, potentially illustrating the dynamic nature of the radio environment and/or the desire for adaptive handover techniques.

In the next panel, FIG. 8 may show a close-up view of a smartphone screen, labeled as "UE Display 8200". This panel may provide a more detailed look at how the parallel CHO process may be represented from the UE's perspective. The screen may display a network status interface, potentially illustrating how the UE may monitor and/or manage multiple potential handover targets simultaneously. At the top of the screen, the text "Conditional Handover Status" may be written in bold, identifying the purpose of the displayed information. Below the header, the panel may show a table with three rows and/or three columns. The column headers may read "Cell ID", "Signal Strength", and/or "CHO Status", providing a structured view of the relevant information for each potential handover target. The first row may contain the values "8110", "Medium", and/or "Current", corresponding to the source cell tower. This row may indicate that the UE is currently connected to Cell 8110, but the signal strength may be only medium, which may suggest why a handover may be considered. The second and third rows may contain the values "8120", "High", "Attempting CHO" and "8130", "High", "Attempting CHO" respectively. These rows may represent the two target cells to which the UE may be attempting parallel conditional handovers. The "High" signal strength for both target cells may suggest that they may be suitable candidates for handover, potentially offering better connectivity than the current serving cell. At the bottom of the UE Display 8200, a status message reading "Parallel CHO in Progress" may be shown. This message may indicate that the UE is actively engaged in the parallel CHO process, potentially attempting handovers to multiple target cells simultaneously. The presence of this status message may highlight the dynamic and/or ongoing nature of the parallel CHO technique, emphasizing that it may be an active process rather than a static configuration.

The middle panel of FIG. 8 may depict a simplified block diagram of the UE's internal components involved in the parallel CHO process. This diagram may provide insight into the internal decision-making and/or processing that may occur within the UE during a parallel CHO procedure. The panel may show a large rectangle labeled "UE 8100", representing the overall device, which may encompass several functional blocks that may be involved in the CHO process. Within the UE 8100 rectangle, three main blocks may be visible: a "Signal Measurement Module 8310", an "Execution Condition Evaluator 8320", and/or a "CHO Initiator 8330". These blocks may represent functional components or software modules that may work together to implement the parallel CHO technique. The Signal Measurement Module 8310 may be responsible for monitoring the radio environment, measuring signal strengths and/or qualities from various cells, including the serving cell and/or potential target cells. This module may provide the raw data used to make informed handover decisions. Arrows may be shown connecting these blocks, illustrating the flow of information within the UE during the CHO process. Arrows may lead from the Signal Measurement Module 8310 to the Execution Condition Evaluator 8320, indicating that the measured signal data is passed to the evaluator for analysis. The Execution Condition Evaluator 8320 may be responsible for comparing the measured signal data against predefined handover conditions or thresholds. This evaluation process may determine whether the conditions for initiating a handover to one or more target cells have been met. An arrow may then lead from the Execution Condition Evaluator 8320 to the CHO Initiator 8330, suggesting that once the execution conditions are met, the CHO Initiator 8330 may be triggered to begin the handover process. The CHO Initiator 8330 may be responsible for managing the actual handover attempts, potentially including sending Random Access Channel (RACH) messages to target cells and/or coordinating the parallel handover attempts. Above the Execution Condition Evaluator 8320, a thought bubble may be shown reading "Conditions met for Cell 8120 and Cell 8130". This bubble may represent the outcome of the evaluation process, indicating that the handover conditions have been satisfied for two potential target cells simultaneously. This visualization may highlight one aspect of the parallel CHO technique, where multiple target cells may be considered and/or attempted in parallel, potentially improving the chances of a successful handover in challenging network conditions.

Beneath the middle panel, the next panel of FIG. 8 provides a visualization of the parallel CHO attempts in action. On the left side of this panel, the UE 8100 (represented by the car) is shown sending two distinct RACH messages simultaneously. These messages are labeled as "RACH Message 8410" and "RACH Message 8420". Dotted lines with arrowheads extend from the UE 8100 to Target Cell Tower 8120 and/or Target Cell Tower 8130, representing the transmission of these RACH messages. This visualization may illustrate one aspect of the parallel CHO technique, where the UE may initiate handover procedures with multiple target cells at the same time, potentially reducing overall handover latency and/or improving the chances of a successful handover. On the right side of this panel, the UE 8100 is shown receiving responses from both target cells. These incoming messages are labeled as "CHO Response 8430" and/or "CHO Response 8440". The simultaneous reception of these responses may illustrate the parallel nature of the CHO process, potentially highlighting how the UE may handle multiple handover procedures concurrently. This parallel processing may allow the UE to quickly select the most suitable target cell based on the responses received, potentially leading to more efficient and/or reliable handover outcomes.

The bottom panel of FIG. 8 illustrates the successful completion of a parallel Conditional Handover (CHO) attempt. This panel depicts the UE 8100, represented by the car, positioned closer to the Target Cell Tower 8120. A solid line connecting the UE 8100 to Target Cell Tower 8120 is visible, labeled as "New Connection 8510". This solid connection line may represent the establishment of a stable link between the UE 8100 and/or the selected target cell, potentially indicating the successful execution of the handover process. The panel also shows the smartphone screen again, similar to the second-from-top panel, but with updated status information. The table on the screen may now displays modified values, reflecting the outcome of the parallel CHO process. The first row shows "8110", "Low", "Disconnected", which indicates that the UE 8100 has disconnected from the original source cell. The second row displays "8120", "High", "Connected", signifying that the UE 8100 has successfully connected to the target cell that provided the strongest or most suitable signal. The third row shows "8130", "Medium", "CHO Cancelled", which suggests that the parallel CHO attempt to this cell was terminated due to the successful connection established with the preferred target cell. At the bottom of the screen, a message reading "CHO Completed: Connected to Cell 8120" is visible. This message serves to indicate the final outcome of the parallel CHO process, confirming which cell the UE 8100 has ultimately connected to. In some examples, this final panel may illustrate how the parallel CHO technique may allow for efficient selection of the most suitable target cell, potentially leading to improved connection quality and/or user experience. The updated display may also demonstrate how the UE 8100 may manage and/or track multiple CHO attempts simultaneously, and/or how it may quickly adapt to changing network conditions by selecting the most appropriate cell for connection.

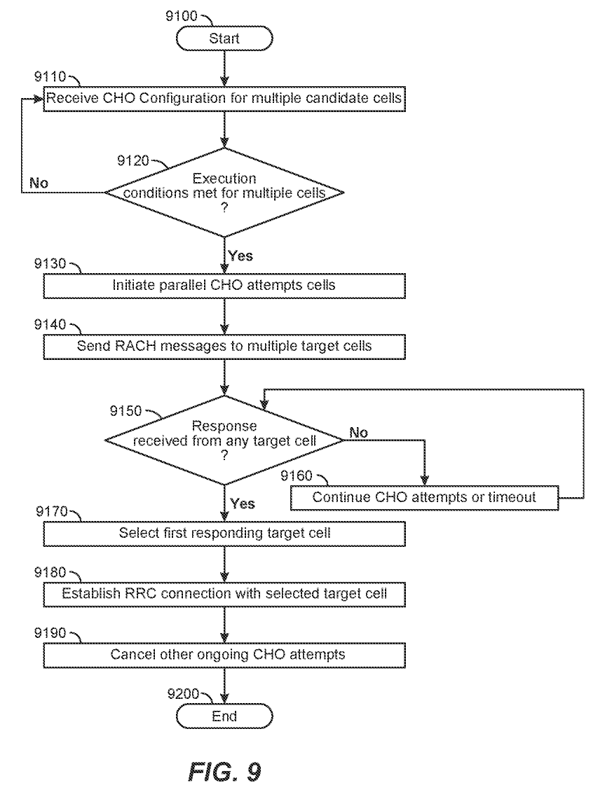

FIG. 9 shows an example flowchart illustrating a user equipment (UE) decision-making process for initiating and/or managing parallel Conditional Handover (CHO) attempts. The flowchart may present a vertically oriented sequence of steps, representing the logical flow of operations performed by a UE during the parallel CHO process. This visual representation may provide insight into the decision points and/or actions taken by the UE throughout the handover procedure.

The flowchart begins with a rounded rectangle labeled "START" 9100 at the top of the diagram. This starting point represents the initiation of the parallel CHO process, which occurs when the UE enters a state where handover considerations become relevant. From this starting point, an arrow leads to a process box labeled "Receive CHO configuration for multiple candidate cells" 9110. This step represents the UE receiving information about potential target cells for handover from the network. The CHO configuration received in this step may include details such as cell identifiers, frequency information, and/or criteria for initiating handover attempts. This configuration information may be helpful in allowing the UE to prepare for potential handovers to multiple cells simultaneously. The reception of this configuration may be a first step in the parallel CHO process, as it may provide the UE with the information used to evaluate multiple potential handover targets concurrently. This may differ from standard handover procedures where the UE may only consider one target cell at a time, potentially leading to more efficient and/or robust handover performance in challenging network environments.

Following the reception of CHO configuration, an arrow leads to a decision diamond labeled "Execution conditions met for multiple cells?" 9120. This decision point represents the UE's ongoing evaluation of the radio environment and/or comparison of measured parameters against the received CHO criteria. The UE may monitor continuously or otherwise for signals from various cells and/or assess whether the conditions for initiating a handover have been met for more than one candidate cell. This evaluation process may be helpful in identifying opportunities for parallel handover attempts, potentially improving the efficiency and/or reliability of the handover process in challenging network conditions. The decision diamond 9120 may determine whether the UE proceeds with simultaneous handover attempts or continues monitoring the current conditions. This continuous evaluation may allow the UE to adapt quickly to changing network conditions, potentially reducing the likelihood of dropped connections or service interruptions in dynamic radio environments.

From the decision diamond 9120, two arrows may emerge, representing different outcomes of the condition evaluation. An arrow labeled "NO" loops back to the "Receive CHO configuration" box 9110, indicating that if the execution conditions are not met for multiple cells, the UE continues to monitor conditions and/or potentially receive updated configuration information. This feedback loop illustrates the dynamic nature of the CHO process, where the UE may adapt to changing network conditions over time. The ability to return to the configuration reception step may allow the UE to remain responsive to network changes, potentially receiving updated criteria or cell information as needed. Conversely, an arrow labeled "YES" proceeds downward to the next step, representing the case where execution conditions are satisfied for multiple candidate cells. This path leads to the initiation of parallel handover attempts.

The "YES" path leads to a process box labeled "Initiate parallel CHO attempts" 9130. This step represents the UE beginning the CHO process for multiple cells simultaneously. By initiating handover attempts to multiple cells in parallel, the UE may increase its chances of successfully transitioning to a new cell, potentially reducing handover failures in challenging radio environments. This parallel initiation may involve preparing resources for multiple potential handovers, which may include allocating memory for different cell configurations, preparing multiple security contexts, and/or readying the UE's radio resources for potential connections to different cells. From this box, an arrow leads to another process box labeled "Send RACH messages to multiple target cells" 9140. This step illustrates the UE sending Random Access Channel (RACH) messages to initiate the handover process with multiple target cells concurrently. The parallel transmission of RACH messages may be helpful in reducing overall handover latency and/or improving the likelihood of a successful handover. By sending RACH messages to multiple cells simultaneously, the UE may effectively "race" the potential target cells against each other, potentially selecting the most responsive or suitable cell for the final handover.

Following the RACH message transmission, an arrow leads to a decision diamond labeled "Response received from any target cell?" 9150. This decision point represents the UE waiting for and/or evaluating responses from the target cells to which it sent RACH messages. The UE may monitor for responses within a certain timeframe, potentially balancing the desire for quick handover execution with the desire to allow sufficient time for responses from all target cells. This step in the flowchart illustrates the moment where the UE determines whether any of its parallel handover attempts have been acknowledged by the target cells. The decision diamond 9150 may play a role in determining the subsequent actions of the UE, as the presence or absence of responses may significantly influence the handover process. In scenarios where multiple responses are received, this step may also involve evaluating the quality or timing of these responses to determine the most suitable target cell for completing the handover.

From the decision diamond 9150, two arrows emerge, representing different scenarios based on the received responses. An arrow labeled "NO" leads to a process box labeled "Continue CHO attempts or timeout" 9160. This step represents the UE's behavior when no responses are received from the target cells within an expected timeframe. The UE may choose to continue its CHO attempts, potentially by retrying RACH transmissions or adjusting its strategy, or it may implement a timeout mechanism to avoid indefinite waiting. This process box 9160 illustrates the adaptability of the parallel CHO technique, allowing for multiple attempts or strategic timeouts to increase the chances of a successful handover. The option to continue attempts or implement a timeout may be helpful in scenarios where network conditions are challenging or when the initial parallel attempts fail to yield a response. From this box, an arrow loops back to the response evaluation diamond 9150, illustrating the iterative nature of this process. This feedback loop may allow the UE to persist in its handover attempts while continually reassessing the situation, potentially improving the robustness of the handover process in difficult network conditions.

Conversely, an arrow labeled "YES" proceeds downward from the decision diamond 9150, representing the case where at least one response is received from a target cell. This path leads to a process box labeled "Select first responding target cell" 9170. This step represents the UE choosing the cell that responded first to complete the handover. By selecting the first responder, the UE may minimize handover latency and/or quickly establish a connection with an available target cell. The selection of the first responding cell illustrates how the speed of response may be used as a criterion for choosing the target cell. This approach may be beneficial in scenarios where quick handover execution is desirable, such as in high-mobility situations or rapidly changing network conditions. However, additional criteria beyond just the speed of response may be considered in this selection process, potentially including signal strength, quality of service parameters, and/or other relevant factors.

From the selection box 9170, an arrow leads to another process box labeled "Establish RRC connection with selected target cell" 9180. This step illustrates the UE finalizing the handover process by establishing a Radio Resource Control (RRC) connection with the chosen target cell. The establishment of this RRC connection marks the successful completion of the handover to the new cell. This process may involve a series of signaling exchanges between the UE and the selected target cell to set up the parameters for communication. The RRC connection establishment may include steps such as security activation, bearer configuration, and synchronization of various protocol layers. The successful completion of this step indicates that the UE has effectively transitioned its active connection from the source cell to the new target cell, potentially achieving improved signal quality and/or network performance as a result of the handover. Optionally, in an alternative embodiment, if the RACH process fails at the stage “Select first responding target cell,” then the device should attempt (e.g., immediately attempt) to connect with the second responding target cell.

Following the RRC connection establishment, an arrow leads to a process box labeled "Cancel other ongoing CHO attempts" 9190. This step represents the UE optionally terminating the CHO processes for other cells that were part of the parallel attempt but were not selected for the final handover. By cancelling these other attempts, the UE may free up resources and/or avoid unnecessary network signaling. This cancellation process may involve sending messages to the non-selected target cells to inform them that their resources are no longer needed for this handover. Additionally, the UE may release any internal resources that were allocated for these parallel attempts. The inclusion of this step in the flowchart highlights efficiency aspects of the parallel CHO technique, where multiple options are explored simultaneously, but unnecessary processes are optionally promptly terminated once a successful path is identified.

Finally, an arrow leads from the cancellation box 9190 to a rounded rectangle labeled "END" 9200 at the bottom of the flowchart, signifying the completion of the parallel CHO process. This end point represents the conclusion of the handover procedure, with the UE now successfully connected to the new target cell and all parallel attempts resolved.

FIG. 10 shows an example dynamic cell sorting and selection process for Conditional Handover (CHO). The figure consists of six panels (1000, 2000, 3000, 4000, 5000, 6000) arranged in two rows of three, illustrating three scenarios of the cell sorting and selection process for CHO. Each scenario presents two stages to demonstrate the dynamic nature of the process. This multi-panel approach may allow for a comprehensive visualization of how the CHO process may adapt to various network conditions and/or scenarios, potentially providing insights into the flexibility and/or efficiency of the technique. The progression through multiple scenarios may demonstrate how the algorithm may handle different challenges, such as changing signal strengths, failed handover attempts, and/or the need to implement retry limitations. By presenting these scenarios side by side, the figure may facilitate a comparison of how the CHO process may evolve and/or adapt in different situations, potentially highlighting the robustness of the technique in diverse network environments.

In the top-left panel 10000, labeled "Initial Sort," a UE 1010 is represented by a smartphone icon in the bottom left corner. Above the UE 10010, four cell towers (1020, 1030, 1040, 1050) are shown with their respective signal strengths: -95 dBm, -100 dBm, -85 dBm, and -90 dBm. To the right of the towers, a sorting arrow 1060 points downwards. Below the arrow, the sorted towers are displayed in order of signal strength: 1040 (-85 dBm), 1050 (-90 dBm), 1020 (-95 dBm), 1030 (-100 dBm). Towers 1040 and 1050 are circled, indicating they are chosen for CHO attempts. This initial sorting process demonstrates how the UE 10010 prioritizes potential target cells based on signal strength. The visual representation of signal strengths and the sorted order may provide a clear illustration of how the CHO process may initially select target cells. By choosing the two cells with the strongest signals (1040 and 1050), the process may aim to maximize the likelihood of a successful handover. This approach may be helpful in scenarios where signal strength is a primary indicator of cell quality and/or suitability for handover. The panel may also suggest that the CHO process may consider multiple potential targets simultaneously, which may be one aspect of the parallel CHO technique.

The top-middle panel 2000, "Scenario 1 - After Failed Attempts," presents an updated view of the situation. The UE 1010 and the four towers (1020, 1030, 1040, 1050) are redrawn with new signal strengths: -95 dBm, -98 dBm, -92 dBm, and -88 dBm respectively. A sorting arrow 2060 shows the new order: 1050, 1040, 1020, 1030. Towers 1040 and 1050 are crossed out, indicating failed CHO attempts, while towers 11020 and 11030 are circled to show new CHO attempt targets. A callout 2070 displays a person holding a phone, connected to tower 1020 by a dotted line. This panel illustrates how the CHO process may adapt to failed handover attempts and changing signal conditions. The UE 1010 may reassess the available cells and select new targets based on the most recent measurements, potentially improving the chances of a successful handover in dynamic network environments. The inclusion of updated signal strengths may demonstrate how network conditions may change rapidly, indicating a flexible handover technique. The callout 2070 showing a connection to tower 1020 may suggest that the CHO process may successfully establish a new connection even after initial attempts fail, potentially highlighting the resilience of the technique.

The top-right panel 3000, "Scenario 2 - Initial Sort," introduces a fifth tower to the scenario. The UE 1010 is shown with five towers (1020, 1030, 1040, 1050, 1060) and their signal strengths: -100 dBm, -95 dBm, -85 dBm, -90 dBm, and -88 dBm. The sorting process 3070 results in the order: 1040, 1060, 1050, 1030, 1020. Towers 1040 and 1060 are circled as chosen CHO targets. This scenario demonstrates how the sorting algorithm may handle a larger number of potential target cells, still selecting the two strongest signals for CHO attempts. The introduction of an additional tower may illustrate how the CHO process may scale to accommodate more complex network environments. By maintaining the same sorting and selection principles even with an increased number of options, the technique may demonstrate consistency and/or scalability. The visual representation of five towers with varying signal strengths may provide a clear picture of a more diverse network landscape, potentially simulating real-world scenarios where multiple cells may be within range of a UE.

The bottom-left panel 4000 of FIG. 10 shows an example of "Scenario 2 - Updated List," which may illustrate how the Conditional Handover (CHO) process may adapt to changing signal strengths in a dynamic network environment. In this panel, the UE 1010 is depicted alongside five cell towers (1020, 1030, 1040, 1050, 1060), each with updated signal strength values. The signal strengths for these towers are now: -94 dBm, -88 dBm, -96 dBm, -90 dBm, and -98 dBm, respectively. These new values may represent changes in the network conditions that may have occurred since the initial sorting shown in the top-right panel. Such fluctuations in signal strength may be indicative of real-world scenarios where factors such as UE movement, environmental changes, and/or variations in network load may impact signal quality. The visual representation of these changing signal strengths may provide insights into how the CHO technique may handle dynamic network conditions, potentially adapting its handover strategies in real-time to maintain optimal connectivity for the UE.

The new sorting arrow 4070 indicates the revised order based on these updated signal strengths. The correct sorting from strongest to weakest signal is now: 1030 (-88 dBm), 1050 (-90 dBm), 1020 (-94 dBm), 1040 (-96 dBm), 1060 (-98 dBm). This reordering may demonstrate how the CHO process may continuously reassess the available cells and/or update its target selection based on the most recent measurements. Such adaptive behavior may be helpful in maintaining optimal connection quality in dynamic network environments where signal strengths may fluctuate due to various factors such as UE movement, environmental changes, and/or variations in network load. The ability to dynamically sort and/or prioritize potential target cells may allow the CHO technique to respond quickly to changing network conditions, potentially improving the overall efficiency and/or reliability of the handover process. In some examples, this sorting mechanism may take into account not only the absolute signal strength values but also the relative changes in signal strength over time, which may provide additional context for making informed handover decisions.

In this updated scenario, towers 1040 and 1060 are marked with X's, indicating that the CHO attempts initiated in the top-right panel were unsuccessful. This visual indication may illustrate how the CHO process may handle failed handover attempts and/or adapt to changing signal conditions. The marking of these towers with X's may suggest that the CHO technique may track the outcomes of previous attempts and/or use this information to inform subsequent decisions. This feature may be helpful in avoiding repeated attempts to cells that have recently failed, potentially improving the efficiency of the overall handover process. In some scenarios, this information may be used to implement temporary cooldown periods for failed cells, during which they may not be considered for immediate re-attempt, potentially allowing for network conditions to stabilize or for other factors affecting the failed attempt to potentially resolve. Additionally, the tracking of failed attempts may contribute to a learning process within the CHO system, where patterns of failures may be analyzed to potentially improve future handover decisions or to identify persistent issues with specific cells or network areas.

Conversely, towers 1030 and 1050 are now circled, indicating that they have been selected as the new CHO targets. This selection may be based on their current signal strengths, which are now among the strongest in the updated measurements. The circling of these new target towers may visually represent how the CHO technique may flexibly respond to changing network conditions by selecting the most promising candidates for handover attempts at any given time. A callout 4080 is added to this panel, showing a person holding a phone with a dotted line connecting to tower 1030. This visual element may suggest that the CHO process may have successfully established a new connection to the cell with the strongest current signal (-88 dBm). The inclusion of this callout may highlight the potential benefits of the adaptive CHO technique in ensuring that the UE may maintain the best possible connection quality, even as network conditions evolve. The ability to quickly switch to a new target cell when conditions change may be helpful in minimizing service interruptions and/or maintaining a high-quality user experience. In some examples, the selection of multiple target cells for parallel CHO attempts may provide a form of redundancy, potentially increasing the likelihood of a successful handover in challenging network conditions. This parallel approach may be helpful in scenarios where individual cells may have rapidly fluctuating signal strengths or where there may be a high risk of handover failure due to factors such as network congestion or physical obstacles. The visual representation of successful connection establishment may also serve to illustrate the end goal of the CHO process, emphasizing that despite the complexity of the selection and attempt processes, the ultimate objective is to maintain seamless connectivity for the user.

The bottom-middle panel 5000 of FIG. 10 shows an example of "Scenario 3 - Initial Sort with Retry Limitation," which may illustrate how the Conditional Handover (CHO) process may incorporate retry counts alongside signal strength in its decision-making process. In this panel, the UE 1010 is depicted alongside four cell towers (1020, 1030, 1040, 1050), each with signal strength values and/or associated retry counts. The signal strengths and/or retry counts for these towers are: 1020 (-95 dBm, retry count 1), 1030 (-90 dBm, retry count 2), 1040 (-85 dBm, retry count 0), and/or 1050 (-88 dBm, retry count 1). These values may represent a complex network environment where signal strength alone may not be the sole determining factor for CHO attempts. The inclusion of retry counts in this scenario may demonstrate how the CHO technique may evolve to consider historical performance alongside current signal quality, potentially leading to more informed and/or efficient handover decisions. In some examples, this multi-factor approach may be helpful in scenarios where certain cells may consistently fail to complete handovers despite strong signals, potentially due to factors such as network congestion, interference, and/or other non-signal-related issues. By incorporating retry counts into the decision-making process, the CHO technique may adapt to the real-world performance of cells rather than relying solely on theoretical signal strength measurements, which may lead to improved handover success rates and/or enhanced overall network performance.

A sorting arrow 5060 is displayed, indicating the order of the cell towers based on a combination of their signal strengths and/or retry counts. The sorting order shown is: 1040, 1050, 1030, 1020. This ordering may reflect a balance between the desire for strong signal quality and/or the goal of avoiding repeated failed attempts to the same cell. In this scenario, tower 1040 may be ranked first due to its strong signal (-85 dBm) and/or lack of previous attempts (retry count 0), while tower 1030, despite having a relatively strong signal (-90 dBm), may be ranked lower due to its higher retry count (2). This sorting mechanism may be helpful in scenarios where certain cells consistently fail to complete handovers despite strong signals, potentially due to factors such as network congestion and/or other non-signal-related issues. By incorporating retry counts into the decision-making process, the CHO technique may adapt to the real-world performance of cells rather than relying solely on theoretical signal strength measurements. In some examples, this retry-aware sorting process may help to distribute handover attempts more evenly across available cells, potentially reducing the load on any single cell and/or improving overall network efficiency. Additionally, this approach may be helpful in identifying and/or avoiding cells that may have temporary issues not reflected in their signal strength, such as backhaul problems and/or software glitches, which could lead to failed handovers despite strong signal indicators.

Towers 1040 and/or 1050 are circled in this panel, indicating that they have been selected as the CHO targets. This selection may be based on their combination of strong signals and/or low retry counts, potentially representing the most promising candidates for successful handover attempts. The visual representation of this selection process illustrates how the CHO technique may evolve to make more nuanced decisions, potentially improving the overall success rate of handover attempts in complex network environments. In some examples, this retry-aware selection process may help to distribute handover attempts more evenly across available cells, potentially reducing the load on any single cell and/or improving overall network efficiency. Furthermore, by considering both signal strength and/or past performance, the CHO process may be better equipped to handle scenarios where signal strength alone may not be a reliable indicator of handover success probability. This multi-factor approach may be helpful in urban environments with dense cell deployments, where interference and/or network congestion may play significant roles in handover outcomes. The circling of multiple targets may also suggest that the CHO technique may prepare for parallel handover attempts, potentially increasing the chances of a successful transition and/or reducing the overall time required for the handover process.

The bottom-right panel 6000 of FIG. 10 presents an example of "Scenario 3 - Updated List with Retry Prevention," which may demonstrate how the CHO process may further adapt its cell selection based on updated signal strengths and/or increased retry counts. In this panel, the UE 1010 is again shown with the four cell towers (1020, 1030, 1040, 1050), but their signal strengths and/or retry counts have changed to: 1020 (-92 dBm, retry count 1), 1030 (-88 dBm, retry count 3), 1040 (-90 dBm, retry count 1), and 1050 (-86 dBm, retry count 2). These updated values may represent the dynamic nature of network conditions and/or the potential outcomes of previous CHO attempts. The changes in both signal strengths and/or retry counts may illustrate how network conditions may evolve over time and/or how the CHO technique may need to continuously reassess its target cell selection. In some examples, this dynamic reassessment may be helpful in adapting to rapidly changing network environments, such as those encountered in high-mobility scenarios and/or areas with fluctuating user densities. The ability to quickly update and/or re-evaluate potential handover targets based on the most current information may be helpful in maintaining optimal connectivity for users, even in challenging and/or unpredictable network conditions.

A new sorting arrow 6060 is shown, indicating the revised order of the cell towers based on the updated signal strengths and/or retry counts. The new sorting order may be: 1050, 1040, 1020, 1030. This reordering may demonstrate how the CHO process may dynamically adjust its priorities based on the most current information available. In this updated scenario, tower 1030 is now crossed out, indicating that it has exceeded a predetermined retry limit and/or may be temporarily excluded from CHO attempts. This visual indication may illustrate how the CHO technique may implement retry prevention mechanisms to avoid repeatedly attempting handovers to cells that have consistently failed in recent attempts. Such a mechanism may be helpful in preventing the waste of network resources on likely-to-fail handover attempts and/or may encourage the exploration of alternative cells that may offer better chances of successful handover. In some examples, this retry prevention feature may also serve as a form of temporary cell blacklisting, allowing the network to automatically adapt to persistent issues with specific cells without requiring manual intervention. This automated adaptation may be helpful in scenarios where cell performance may be degraded due to temporary factors such as maintenance activities, environmental conditions, and/or unexpected hardware issues.

Towers 1050 and/or 1040 are circled in this panel, suggesting they have been selected as the new CHO targets. This selection may be based on their current combination of signal strengths and/or retry counts, potentially representing the most promising candidates for successful handover attempts given the updated network conditions. A callout 6070 is added to this panel, showing a person holding a phone with a dotted line connecting to tower 1050. This visual element may suggest that the CHO process may have successfully established a new connection to the cell with the strongest current signal (-86 dBm) and/or a moderate retry count (2). The inclusion of this callout may highlight how the retry-aware CHO technique may successfully navigate complex network conditions to establish stable connections, potentially improving overall user experience in challenging network environments. In some examples, the retry prevention mechanism illustrated in this scenario may be helpful in load balancing across the network. By temporarily excluding cells with high retry counts, the CHO process may encourage the distribution of connection attempts across a wider range of available cells, potentially leading to more efficient utilization of network resources. Additionally, this technique may be helpful in scenarios where certain cells may be experiencing temporary issues that are not reflected in their signal strength measurements. By considering both signal strength and/or past performance, the CHO process may make more informed decisions that account for a broader range of factors affecting connection quality and/or stability, potentially resulting in a more robust and/or reliable mobile network experience for users.

In some examples, the Conditional Handover (CHO) process may involve a dynamic selection and sorting technique that adapts to changing network conditions over multiple rounds of handover attempts. This technique may begin by evaluating a set of candidate cells, such as towers A, B, C, D, and E, based on their signal strengths. Initially, the User Equipment (UE) may choose the two cells with the strongest signals for the first CHO attempt. For instance, if towers C and D have the highest signal strengths, the UE may initiate parallel handover attempts to these two cells. After this initial attempt, the UE may take new measurements of the signal strengths for all candidate cells. If the same two cells (C and D in this example) still have the strongest signals, the UE may attempt handovers to these cells again, even if the previous attempts failed. This approach may be based on the rationale that signal strength remains a primary indicator of potential connection quality, and temporary issues that caused the initial failure may have been resolved. The UE may prefer this relatively simple decision-making process, as implementing more complex algorithms for cell selection may introduce additional computational overhead and/or potential points of failure. However, to prevent excessive attempts to the same cells, the UE may implement a retry limit, consistent with panel 6000. This limit may be particularly helpful in scenarios where persistent attempts to the same cells may be unproductive, such as when there are underlying network issues affecting those specific cells. The retry limit may be a fixed number of attempts, or it may be dynamically adjusted based on factors such as the urgency of the handover, overall network conditions, and/or the UE's battery status. In a subsequent round of measurements, the UE may encounter a different signal strength ordering. For example, towers A and E may now have the strongest signals. In this case, the UE may initiate new CHO attempts to these cells, potentially increasing the chances of a successful handover by exploring different options. This multi-round, adaptive approach may be helpful in dealing with rapidly changing network environments, where the optimal target cell may shift over short periods. The technique may also incorporate a way to update the list of candidate cells dynamically. For instance, if a new cell becomes available or if an existing cell's signal strength improves significantly, the UE may include these in its selection process for future CHO attempts. Conversely, cells that consistently fail handover attempts or show persistently weak signals may be temporarily or permanently removed from the candidate list. This dynamic updating of the candidate cell list may help ensure that the UE always considers the most viable options for handover, potentially improving the overall success rate and efficiency of the CHO process.

In some examples, the Conditional Handover (CHO) and Basic Handover (BHO) procedures may be defined by various telecommunications standards, such as those developed by the 3rd Generation Partnership Project (3GPP). These standards, including but not limited to 3GPP TS 38.300 and 3GPP TS 38.331, may provide detailed specifications for handover processes in 5G New Radio (NR) networks. However, the techniques described herein may not be limited to these specific standards and may be applicable to other existing and/or future standards that define similar handover procedures. For instance, standards governing handovers in 4G Long-Term Evolution (LTE) networks, Wi-Fi networks, or other Radio Access Technologies (RATs) may incorporate comparable mechanisms for managing cell transitions. Future revisions of these standards and/or entirely new standards may also adopt and/or adapt the principles of parallel conditional handover attempts. The relevance of the techniques described in this application may extend to any standard that includes provisions for UE measurement reporting, network-initiated handover commands, and/or UE-autonomous handover execution. Additionally, standards that define multi-connectivity scenarios, where a UE may maintain simultaneous connections to multiple RATs, may particularly benefit from these techniques. The concepts of parallel handover attempts, dynamic cell list management, and adaptive retry mechanisms may be implemented within the framework of various standards, provided they allow for UE-side decision making in the handover process. Furthermore, as telecommunications standards continue to evolve, they may increasingly incorporate features that facilitate more advanced handover techniques, such as enhanced measurement reporting capabilities, more granular network configuration options, and/or improved signaling protocols between network entities. These advancements may further enhance the applicability and effectiveness of the parallel CHO techniques described herein across a wide range of network technologies and standards.

In some examples, a user equipment (UE) may initiate parallel Conditional Handover (CHO) attempts to at least three candidate target cells. This technique may expand upon the concept of dual-cell parallel CHO attempts by including additional target cells in the simultaneous handover process. The UE may receive configuration information for multiple candidate target cells, which may include parameters and execution conditions for a larger set of potential handover targets. Upon determining that execution conditions are satisfied for three or more of these candidate target cells, the UE may initiate CHO attempts to each of these cells in parallel. This parallel initiation may involve sending Random Access Channel (RACH) messages or other appropriate signaling to the selected target cells simultaneously or in rapid succession. The UE may be configured to manage and track the progress of these multiple concurrent handover attempts, potentially improving the likelihood of a successful handover in challenging network environments. The number of parallel CHO attempts may not be limited to three, and may instead be dynamically determined based on factors such as network conditions, UE capabilities, and operator policies. In some scenarios, the UE may be capable of initiating CHO attempts to four, five, or even more candidate target cells simultaneously. This expanded parallel CHO technique may be helpful in dense urban environments or high-mobility situations where multiple viable target cells may be available. The UE may employ sophisticated algorithms to prioritize and manage these multiple parallel attempts, potentially considering factors such as signal strength, quality of service requirements, and historical performance data for each candidate cell. Additionally, the UE may be configured to adaptively adjust the number of parallel CHO attempts based on real-time feedback and results from ongoing handover processes. For instance, if initial attempts to certain cells fail quickly, the UE may initiate additional parallel attempts to other candidate cells without waiting for all original attempts to conclude. This dynamic approach may help maintain a consistent number of active CHO attempts, potentially maximizing the chances of a successful handover. The UE may also implement intelligent resource allocation strategies to efficiently manage the increased signaling and processing demands associated with multiple parallel CHO attempts. This may involve prioritizing certain attempts based on their likelihood of success and/or the criticality of maintaining service continuity for specific applications or services.

In some examples, a user equipment (UE) may limit the number of parallel Conditional Handover (CHO) attempts to two. This technique may strike a balance between the benefits of parallel handover attempts and the desire to conserve UE resources. By limiting the number of simultaneous CHO attempts, the UE may efficiently manage its processing power, battery life, and network signaling overhead. The UE may employ various strategies to select the two most promising candidate cells for parallel CHO attempts. These strategies may include, but may not be limited to, sorting candidate cells based on signal strength, historical performance data, or a combination of multiple factors. The UE may dynamically update its selection criteria based on real-time network conditions and feedback from previous handover attempts. In some scenarios, the UE may implement a phased approach, where it initially attempts CHO to the two highest-ranked candidate cells, and if these attempts fail, it may proceed to the next two candidates in the list. This iterative process may continue until a successful handover is achieved or until all candidate cells have been exhausted. The UE may also employ adaptive timers to manage the duration of each pair of parallel CHO attempts, potentially adjusting these timers based on network responsiveness and the urgency of the handover. In some examples, the UE may incorporate machine learning algorithms to improve its cell selection process over time, potentially learning from successful and unsuccessful handover patterns to refine its decision-making. The limitation to two parallel CHO attempts may not be a fixed constraint, and the UE may be designed to dynamically adjust this limit based on various factors. For instance, in high-mobility scenarios or areas with rapidly changing network conditions, the UE may temporarily increase the limit to three or more parallel attempts to improve handover success rates. Conversely, in stable network environments or when battery conservation is prioritized, the UE may reduce the limit to a single CHO attempt at a time. The UE may also consider the type of active services or applications when determining the number of parallel CHO attempts, potentially allocating more resources for handovers during latency-sensitive activities. Additionally, the UE may implement fallback mechanisms where, if both parallel CHO attempts fail, it may revert to a traditional handover process or initiate a new round of parallel attempts with different candidate cells.

In some examples, a user equipment (UE) may re-evaluate execution conditions for an updated list of candidate target cells and determine that a first target cell still satisfies the execution conditions due to consistent signal strength. This technique may be part of a broader adaptive strategy for managing Conditional Handover (CHO) attempts in dynamic network environments. The UE may continuously monitor and update its list of candidate target cells based on various factors, including but not limited to signal strength measurements, quality indicators, and historical performance data. When a CHO attempt fails, the UE may not immediately discard the target cell from consideration for future attempts. Instead, it may re-assess the cell's suitability based on the most recent measurements and network conditions. In scenarios where the first target cell maintains a consistent signal strength despite a previous failed CHO attempt, the UE may choose to re-attempt CHO to this cell. This decision may be influenced by various factors, such as the stability of the signal over time, the relative strength compared to other candidate cells, and the reason for the initial failure if it may be determined. The UE may implement sophisticated algorithms to weigh these factors and determine the likelihood of success for a repeated CHO attempt. In some cases, the UE may assign a higher priority to cells that have demonstrated consistent signal strength, even if a previous attempt was unsuccessful, as this consistency may indicate a potentially stable connection. The re-evaluation process may also consider the time elapsed since the previous attempt, potentially allowing for a cool-down period before re-attempting CHO to the same cell. This cool-down period may be dynamically adjusted based on network conditions and the urgency of the handover. Additionally, the UE may implement a system of retry counters or scores for each candidate cell, which may be updated based on the outcomes of CHO attempts and re-evaluations. These scores may influence the decision to re-attempt CHO to a particular cell, with higher scores potentially indicating a greater likelihood of success. The UE may also consider the broader network context when deciding to re-attempt CHO to a previously failed cell, such as the availability and suitability of other candidate cells, overall network load, and the UE's current mobility pattern. In some scenarios, the UE may alternate between attempting CHO to new cells and re-attempting to previously failed cells with consistent signal strength, potentially maximizing its chances of successful handover while also exploring new options.

In some examples, a user equipment (UE) may re-evaluate execution conditions for an updated list of candidate target cells and determine that neither the first target cell nor the second target cell satisfies the execution conditions due to degraded signal quality. This scenario may prompt the UE to attempt Conditional Handover (CHO) to two new target cells from the updated list. The process of re-evaluating execution conditions may involve a comprehensive analysis of various network parameters and signal quality metrics. The UE may employ sophisticated algorithms to assess the current radio environment and compare it with the stored execution conditions for each candidate cell. These execution conditions may include, but may not be limited to, Reference Signal Received Power (RSRP) thresholds, Reference Signal Received Quality (RSRQ) thresholds, and/or Signal-to-Interference-plus-Noise Ratio (SINR) requirements. The UE may also consider additional factors such as cell load, historical performance data, and predicted future signal trends based on the UE's movement patterns. In scenarios where the signal quality of previously attempted target cells has degraded, the UE may dynamically update its candidate cell list, potentially removing or deprioritizing cells that no longer meet the required criteria. This updating process may involve not only the removal of unsuitable cells but also the addition of new potential target cells that may have become viable options due to changes in the network environment or the UE's location. The selection of two new target cells for CHO attempts may be based on a variety of criteria, which may be weighted and combined using machine learning algorithms or other advanced decision-making techniques. These criteria may include the current signal strength and quality measurements, the rate of signal improvement or degradation over time, the cell's historical reliability for handovers, and its capacity to support the UE's current service requirements. The UE may also consider the geographic distribution of the candidate cells, potentially preferring a diverse selection that may improve the chances of successful handover in different directions of movement. In some implementations, the UE may employ predictive modeling to anticipate which cells may offer the best connectivity in the near future, based on factors such as the UE's velocity and trajectory. This forward-looking technique may help in selecting target cells that may not only satisfy the current execution conditions but also maintain acceptable signal quality for an extended period after the handover. Additionally, the UE may implement a system of dynamic thresholds for execution conditions, where the criteria for selecting new target cells may be adjusted based on the urgency of the handover situation. For instance, if the current serving cell's signal is rapidly degrading, the UE may temporarily relax certain execution condition thresholds to expand the pool of potential target cells, thereby increasing the chances of a successful handover. The UE may also consider network-provided information, such as neighbor cell lists or handover hints, in conjunction with its own measurements when selecting new target cells for CHO attempts. This hybrid technique may leverage both network intelligence and real-time UE measurements to make more informed decisions about potential handover targets.

FIG. 11 shows a system diagram that describes an example implementation of a computing system(s) for implementing embodiments described herein. The functionality described herein can be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they are agnostic to the underlying cloud infrastructure, allowing higher deployment agility and flexibility. However, FIG. 11 illustrates an example of underlying hardware on which such software and functionality may be hosted and/or implemented.

In particular, shown is example host computer system(s) 1101. For example, such computer system(s) 1101 may execute a scripting application, or other software application, as further discussed above, and/or to perform one or more of the other methods described herein. In some embodiments, one or more special-purpose computing systems may be used to implement the functionality described herein. Accordingly, various embodiments described herein may be implemented in software, hardware, firmware, or in some combination thereof. Host computer system(s) 1101 may include memory 1102, one or more central processing units (CPUs) 1114, I/O interfaces 1118, other computer-readable media 1120, and network connections 1122.

Memory 1102 may include one or more various types of non-volatile and/or volatile storage technologies. Examples of memory 1102 may include, but are not limited to, flash memory, hard disk drives, optical drives, solid-state drives, various types of random access memory (RAM), various types of read-only memory (ROM), neural networks, other computer-readable storage media (also referred to as processor-readable storage media), or the like, or any combination thereof. Memory 1102 may be utilized to store information, including computer-readable instructions that are utilized by CPU 1114 to perform actions, including those of embodiments described herein.

Memory 1102 may have stored thereon control module(s) 1104. The control module(s) 1104 may be configured to implement and/or perform some or all of the functions of the systems or components described herein. Memory 1102 may also store other programs and data 1110, which may include rules, databases, application programming interfaces (APIs), software containers, nodes, pods, clusters, node groups, control planes, software defined data centers (SDDCs), microservices, virtualized environments, software platforms, cloud computing service software, network management software, network orchestrator software, network functions (NF), artificial intelligence (AI) or machine learning (ML) programs or models to perform the functionality described herein, user interfaces, operating systems, other network management functions, other NFs, etc.

Network connections 1122 are configured to communicate with other computing devices to facilitate the functionality described herein. In various embodiments, the network connections 1122 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 1118 may include a video interface, other data input or output interfaces, or the like. Other computer-readable media 1120 may include other types of stationary or removable computer-readable media, such as removable flash drives, external hard drives, or the like.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
receiving, by a user equipment (UE), configuration information for multiple candidate target cells for Conditional Handover (CHO);
determining, by the UE, that execution conditions are satisfied for at least two of the multiple candidate target cells; and
initiating, by the UE, parallel CHO attempts to the at least two candidate target cells, in response to determining that the execution conditions are satisfied for the at least two candidate target cells, such that multiple CHO attempts are in progress simultaneously prior to any of the at least two CHO attempts being successfully completed.

2. The method of claim 1, wherein receiving the configuration information comprises receiving the information from one of: a source base station, a master node in a dual connectivity scenario, or a central network entity.

3. The method of claim 1, wherein the method conforms to 3GPP TS 38.300 or 3GPP TS 38.331.

4. The method of claim 1, further comprising operating in one of: a first mode where only one target cell responds, a second mode where multiple target cells respond, or a third mode where no target cells respond.

5. The method of claim 4, wherein operating in the first mode comprises:
attempting CHO to a first target cell and a second target cell; and
proceeding with CHO to the first target cell when a response is received from the first target cell and no response is received from the second target cell within a time limit.

6. The method of claim 4, wherein operating in the second mode comprises:
attempting CHO to a first target cell and a second target cell; and
proceeding with CHO to whichever of the first target cell or second target cell responds first.

7. The method of claim 4, wherein operating in the third mode comprises:
attempting CHO to a first target cell and a second target cell;
determining that neither the first target cell nor the second target cell responded within a time limit; and
attempting CHO to a third target cell and a fourth target cell.

8. The method of claim 7, further comprising sorting candidate target cells based on signal strength prior to attempting CHO.

9. The method of claim 7, further comprising updating a list of candidate target cells based on measurement reports in response to determining that neither the first target cell nor the second target cell responded within the time limit.

10. The method of claim 9, further comprising:
re-evaluating execution conditions for the updated list of candidate target cells;
determining that the first target cell still satisfies the execution conditions due to consistent signal strength; and
re-attempting CHO to the first target cell.

11. The method of claim 9, further comprising:
re-evaluating execution conditions for the updated list of candidate target cells;
determining that neither the first target cell nor the second target cell satisfies the execution conditions due to degraded signal quality; and
attempting CHO to two new target cells from the updated list.

12. The method of claim 1, further comprising limiting a number of parallel CHO attempts to two.

13. The method of claim 1, wherein initiating parallel CHO attempts comprises sending Random Access Channel (RACH) messages to the at least two candidate target cells.

14. The method of claim 1, wherein the at least two candidate target cells comprise at least three candidate target cells such that parallel CHO attempts are initiated to each of the at least three candidate target cells.

15. The method of claim 1, further comprising establishing a Radio Resource Control (RRC) connection with a first target cell that successfully completes the CHO attempt.

16. The method of claim 1, wherein the execution conditions comprise at least one of a Reference Signal Received Power (RSRP) threshold or a Reference Signal Received Quality (RSRQ) threshold.

17. A non-transitory computer-readable medium that has instructions stored thereon that, when executed by at least one physical computing processor, cause a computing device to perform operations comprising:
receiving, by a user equipment (UE), configuration information for multiple candidate target cells for Conditional Handover (CHO);
determining, by the UE, that execution conditions are satisfied for at least two of the multiple candidate target cells; and
initiating, by the UE, parallel CHO attempts to the at least two candidate target cells, in response to determining that the execution conditions are satisfied for the at least two candidate target cells, such that multiple CHO attempts are in progress simultaneously prior to any of the at least two CHO attempts being successfully completed.

18. The non-transitory computer-readable medium of claim 17, wherein initiating parallel CHO attempts comprises sending Random Access Channel (RACH) messages to the at least two candidate target cells.

19. A system comprising:
at least one physical computing processor of a computing device; and
a non-transitory computer-readable medium that has instructions stored thereon that, when executed by the at least one physical computing processor, cause the computing device to perform operations comprising:
receiving, by a user equipment (UE), configuration information for multiple candidate target cells for Conditional Handover (CHO);
determining, by the UE, that execution conditions are satisfied for at least two of the multiple candidate target cells; and
initiating, by the UE, parallel CHO attempts to the at least two candidate target cells, in response to determining that the execution conditions are satisfied for the at least two candidate target cells, such that multiple CHO attempts are in progress simultaneously prior to any of the at least two CHO attempts being successfully completed.

20. The system of claim 19, wherein initiating parallel CHO attempts comprises sending Random Access Channel (RACH) messages to the at least two candidate target cells.
